(19) United States
(12) Patent Application Publication
(10) Pub. No.: US 2020/0283660 A1
(43) Pub. Date: Sep. 10, 2020

(54) PRESSURE SENSITIVE ADHESIVES CONTAINING ACTIVE ENZYMES

(71) Applicant: 3M INNOVATIVE PROPERTIES COMPANY, ST.PAUL, MN (US)

(72) Inventors: Raj Rajagopal, Woodbury, MN (US); Audrey A. Sherman, Woodbury, MN (US); Scott M. Tapio, Falcon Heights, MN (US); Masayuki Nakamura, Woodbury, MN (US); Ann R.H. Fornof, Austin, TX (US)

(21) Appl. No.: 16/066,108

(22) PCT Filed: Dec. 27, 2016
(86) PCT No.: PCT/US2016/068643

§ 371 Date: Jun. 26, 2018

(51) Int. Cl. C09J 11/08; C09J 7/38; C09J 5/00; B32B 27/06; B32B 37/12; B32B 37/24; B32B 37/02

(52) U.S. Cl. CPC C09J 11/08; B32B 2037/243; C09J 7/387; C09J 7/385; C09J 5/00; B32B 27/06; B32B 37/1284; B32B 37/24; B32B 37/02; C09J 2205/114; C09J 2453/00; C09J 2483/00; C09J 2433/00; C09J 2205/102; C09J 2467/006; C09J 2469/006; C09J 2433/006; C09J 2475/006; C09J 2423/006; B32B 2405/00; B32B 2255/10; B32B 2367/00; C09J 7/38

(57) ABSTRACT

Pressure sensitive adhesive articles include a substrate, and a layer of pressure sensitive adhesive in contact with the substrate. The pressure sensitive adhesive layer includes a pressure sensitive adhesive matrix, and at least one active enzyme dispersed within the pressure sensitive adhesive matrix. The active enzyme remains active for extended periods of time.

### FIELD OF THE DISCLOSURE

The present disclosure relates generally to the field of adhesives, specifically to the field of pressure sensitive adhesives containing active enzymes.

### BACKGROUND

Adhesives have been used for a variety of marking, holding, protecting, sealing and masking purposes. Adhesive tapes generally comprise a backing, or substrate, and an adhesive. One type of adhesive, a pressure sensitive adhesive, is particularly useful for many applications.

Pressure sensitive adhesives are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers and silicones. Each of these classes of materials has advantages and disadvantages.

The use of adhesives, especially pressure sensitive adhesives, in areas such as the medical, electronic and optical industries is increasing. The requirements of these industries place additional demands upon the adhesive beyond the traditional properties of tack, peel adhesion and shear strength. New classes of materials and new techniques for preparing and delivering pressure sensitive adhesives have been developed to meet the increasingly demanding performance requirements for pressure sensitive adhesives.

### SUMMARY

Disclosed herein are pressure sensitive adhesive articles, adhesive laminates, and methods of preparing and using pressure sensitive adhesive articles.

Pressure sensitive adhesive articles are disclosed comprising a substrate, and a layer of pressure sensitive adhesive in contact with the substrate, where the pressure sensitive adhesive layer comprises a pressure sensitive adhesive matrix, and at least one active enzyme dispersed within the pressure sensitive adhesive matrix.

Also disclosed are adhesive laminates comprising a first substrate, a second substrate, and a layer of pressure sensitive adhesive in contact with the first substrate and the second substrate. The pressure sensitive adhesive layer comprises a pressure sensitive adhesive matrix, and at least one active enzyme dispersed within the pressure sensitive adhesive matrix.

Additionally, methods of preparing and using pressure sensitive adhesive articles are disclosed. In some embodiments, the method of making an adhesive article, comprises providing a first substrate with a first major surface and a second major surface, providing a pressure sensitive adhesive or a pressure sensitive adhesive precursor mixture composition, contacting the pressure sensitive adhesive or pressure sensitive adhesive precursor mixture composition to the first major surface of the first substrate, and forming the pressure sensitive adhesive or pressure sensitive adhesive precursor mixture composition into a pressure sensitive adhesive layer. The pressure sensitive adhesive layer or pressure sensitive adhesive precursor mixture composition comprises a polymeric matrix or pre-polymeric reactive mixture, and at least one active enzyme dispersed within the polymeric matrix or pre-polymeric reactive mixture. The adhesive article can be used to prepare laminate articles as described above.

### DETAILED DESCRIPTION

The use of adhesives, especially pressure sensitive adhesives, in areas such as the medical, electronic and optical industries is increasing. The requirements of these industries place additional demands upon the pressure sensitive adhesive beyond the traditional properties of tack, peel adhesion and shear strength. New classes of materials are desirable to meet the increasingly demanding performance requirements for pressure sensitive adhesives.

The need remains for adhesives, especially pressure sensitive adhesives, that have modified properties. One method of modifying the properties of a pressure sensitive adhesive is the use of modifying additives. Adding a modifying additive throughout the bulk of the adhesive layer can dramatically change the properties of the adhesive layer and, depending upon the modifying additive, preparing such modified adhesives can be expensive and labor-intensive. For example, modification of optically clear adhesives throughout the bulk of the adhesive with conductive particles to make the adhesive anti-static or conductive may greatly impair the optical properties of the adhesive. Additionally, the mixing of an anti-static or conductive additive throughout the bulk of the adhesive can add processing time or processing steps to the adhesive formulation as well as expense to the final formulation if, for example the additive is relatively expensive such as silver particles. Therefore, the use of additives that can modify some properties of the pressure sensitive adhesive without adversely affecting other properties of the pressure sensitive adhesive is desirable.

In this disclosure, pressure sensitive adhesive articles are described that include a substrate and a layer of pressure sensitive adhesive in contact with the substrate. The pressure sensitive adhesive layer comprises a pressure sensitive adhesive matrix and at least one active enzyme dispersed within the pressure sensitive adhesive matrix. The addition of the active enzyme to the pressure sensitive adhesive matrix has been found to not adversely affect the properties of the pressure sensitive adhesive matrix, and add a variety of advantageous properties to the pressure sensitive adhesive matrix. Surprisingly, the processing of adhesive compositions that contain enzymes, such as exposure to high temperatures and/or UV radiation during, for example curing, did not adversely affect the activity of the enzymes dispersed within the pressure sensitive adhesive matrix. Additionally, it has surprisingly been found that the enzymes dispersed within the pressure sensitive adhesive matrix remain active for extended periods of time, from 3 months to greater than one year.

As stated above, the presence of the active enzyme dispersed within the pressure sensitive adhesive matrix does not adversely affect the properties of the pressure sensitive adhesive matrix. Thus the conventional pressure sensitive adhesive properties such as peel strength, shear holding power, and tack are essentially the same for the pressure sensitive adhesive matrix either with or without the active enzyme dispersed therein. Additionally, in instances where the pressure sensitive adhesive matrix is optically transparent or optically clear, the optical properties are similarly unaffected by dispersed active enzyme.

There are a number of advantages to having active enzymes dispersed within the pressure sensitive adhesive matrix. Active enzymes have the ability to break down and digest organic residues. Thus, active enzymes present in a pressure sensitive adhesive matrix, can break down and digest small amounts of organic residue on a surface that is in contact with pressure sensitive adhesive matrix. This feature has many applications, among them are in the use of adhesive layers in optical devices and the use of adhesive layers in wound dressings.

In optical devices, adhesive layers are frequently used to adhere a film to substrate, a film to a film, or a substrate to a substrate. Often the adhesive layers are pressure sensitive adhesive layers. In these applications, the adhesive layer is typically optically clear so that visible light passes through the pressure sensitive adhesive matrix without hindrance. This high level of transmission is desirable not only for the function of the optical device, but also for aesthetic reasons. For example, if the optical device is a display device such as computer monitor screen or a cell phone screen, the presence of an adhesive layer that is disruptive to the passage of visible light is very undesirable. The disruption can take many forms, such as the dispersal of light giving haze and lack of clarity, yellowing to give an aesthetically undesirable look to the display screen, or bubbles or other small optical defects that give an undesirable appearance to the display screen.

Many of these defects can be reduced or eliminated by the choice of materials and the methods of lamination of the layers of the optical devices. For example, a wide range of optically clear pressure sensitive adhesives have been developed. Additionally, many of these optically clear pressure sensitive adhesives are chosen to be thermally stable to prevent yellowing. A variety of lamination techniques and processes have been devised (such as the use of microstructuring of the adhesive surface) to eliminate air entrapment between layers and thus prevent the formation of air bubbles in the bond line of a laminated pressure sensitive adhesive matrix. Such materials and techniques have proved to be very successful, but they are unable to prevent the formation of optical defects caused by the presence of contamination on the surface of an optical substrate or film to which an adhesive layer is laminated. For example, if a glass substrate has particles of dust or other contamination present, when an adhesive layer is laminated to that glass substrate, the contamination is permanently trapped. Not only is the trapped contamination itself undesirable, but also it can form a locus for bubble formation. Since the contamination forms a barrier between the substrate and the adhesive layer, trapped air can and will migrate to this point and thus can give an even larger optical defect than the contamination particle itself. In the past, the only methods for prevention of such defects were to carefully clean the substrate surface and to keep the environment where the lamination is carried out as clean as possible. If, despite these efforts, such defects formed, the only choice was to scrap the laminate or to remove the adhesive layer, re-clean the substrate surface and try again. All of these options are expensive, time consuming, and labor intensive. Therefore, the enzymes dispersed in the pressure sensitive adhesive matrices of the present disclosure have the advantage of being able to break down and digest small amounts of organic contamination present in contact with the pressure sensitive adhesive surface. Thus contaminants such as dust and fingerprints, which are organic in nature, are removable by the pressure sensitive adhesive layer without the need to dismantle and re-form the laminate. Additionally, more and more laminations, including optical laminations, are done either by the consumer or on a small scale and thus specialized conditions such as clean room environments and the like are not possible. For example, if a consumer purchases an aftermarket screen protector film to laminate to a screen such as a television, computer monitor, smart phone, or tablet, such a lamination must be performed by hand in the local environment of the consumer, and not under controlled industrial conditions or with professional lamination equipment.

Another advantage of the adhesive layers of the present disclosure is the use of adhesive layers in wound dressings. Adhesive layers are commonly used in wound dressings to hold wound dressings in place. Additionally, anti-bacterial agents and medicaments have been dispersed within the pressure sensitive adhesive layer to prevent infection or to deliver the medicament to the wound. However, the pressure sensitive adhesive layers of the present disclosure have a very different feature, namely they contain active enzymes that are capable of removing dead skin tissues from wounds. The removal of dead skin tissue from wounds, a process called debridement, is desirable for wound healing. At the same time, the removal of live tissue is not desirable, as this can hinder wound healing. Therefore great care has been exercised to develop adhesive layers for wound dressings that do not adhere to wounds so that upon removal of the wound dressing the adhesive layer does not remove tissues from the wound. In the present adhesive articles however, the active enzymes dispersed in the pressure sensitive adhesive matrix are able to break down and digest small amounts of dead skin tissue, without touching the live skin tissue. In this way, wound debridement can be achieved simply by having the wound dressing with active enzymes in place on the wound. Additionally, the articles of this disclosure can be used to prevent and/or remove biofilms on living surfaces such as teeth and wounds, as well as from inanimate surfaces such as, for example, counter tops, table tops, door knobs, keyboards, touch panels, bed rails, toilet surfaces, floors, pipelines, and the like.

The term “adhesive” as used herein refers to polymeric compositions useful to adhere together two adherends. Examples of adhesives are heat activated adhesives, and pressure sensitive adhesives.

Pressure sensitive adhesive compositions are well known to those of ordinary skill in the art to possess at room temperature properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. Obtaining the proper balance of properties is not a simple process.

The term “active enzyme” as used herein refers to enzymes that have not been rendered inactive and thus are able to function as enzymes. Enzymes are macromolecular biological catalysts. Enzymes accelerate, or catalyze, chemical reactions. The molecules at the beginning of the process are called substrates and the enzyme converts these into different molecules, called products. Most enzymes are proteins, although a few are catalytic RNA molecules. Enzymes' specificity comes from their unique three-dimensional structures. Enzymes are highly specific, with respect to both the substrates and the reactions they catalyze. There are six main groups of enzymes: hydrolases;

isomerases; ligases; lyases; oxidoreductases; and transferases. Hydrolases break down proteins, carbohydrates, and fats such as during the process of digestion. They do this by adding a water molecule, thus the name hydrolases. Isomerases catalyze the rearrangement of chemical groups within the same molecule. The ligases catalyze the formation of a bond between two substrate molecules through the use of an energy source. Lyases catalyze the formation of double bonds between atoms by adding or subtracting chemical groups. Oxidoreductases make oxidation-reduction (the process by which an atom loses an electron to another atom) possible. Transferases transfer chemical groups from one molecule to another. Human bodies contain many enzymes from each group.

The term “debridement” as used herein is used according to its normally understood meaning in the medical and dental fields. Debridement is the medical removal of dead, damaged, or infected tissue to improve the healing potential of the remaining healthy tissue. In oral hygiene and dentistry, debridement refers to the removal of plaque and calculus that have accumulated on the teeth.

The term “biofilm” as used herein refers to its commonly used definition in the biological sciences, and refers to an undesirable feature which the enzyme-containing adhesive articles of the present disclosure can be used to prevent and/or remove. A biofilm is any group of microorganisms in which cells stick to each other on a surface. These adherent cells are frequently embedded within a self-produced matrix of extracellular polymeric substance (EPS). Biofilm extracellular polymeric substance, which is also referred to as slime (although not everything described as slime is a biofilm), is a polymeric conglomeration generally composed of extracellular DNA, proteins, and polysaccharides. Biofilms may form on living or non-living surfaces and can be prevalent in natural, industrial and hospital settings.

The term “inanimate” as used herein to describe a surface, is used according to its conventionally understood meaning, and refers to a non-living surface. Examples of inanimate surfaces include for example, counter tops, table tops, door knobs, keyboards, touch panels, bed rails, toilet surfaces, floors, pipelines, and the like.

The term “optically clear” as used herein refers to an adhesive or article that has a high light transmittance over at least a portion of the visible light spectrum (about 400 to about 700 nanometers), and that exhibits low haze. An optically clear material often has a luminous transmission of at least about 90 percent and a haze of less than about 2 percent in the 400 to 700 nm wavelength range. Both the luminous transmission and the haze can be determined using, for example, the method of ASTM-D 1003-95.

The terms “room temperature” and “ambient temperature” are used interchangeably and refer to a temperature of from 20-25° C. The temperature is assumed to be ambient unless otherwise indicated.

The terms “glass transition temperature” and “Tg” are used interchangeably. The Tg when measured, is measured using DSC (Differential Scanning calorimetry) using standard techniques (typically a heating rate of 10° C. per minute) unless otherwise indicated. More typically, the Tg is not measured but rather is calculated with the well-understood Fox equation using the monomer Tg values provided by the monomer supplier, as is well understood by one of skill in the polymer arts.

Disclosed herein are pressure sensitive adhesive articles comprising a substrate and a layer of pressure sensitive adhesive in contact with the substrate. The pressure sensitive adhesive layer comprises a pressure sensitive adhesive matrix and at least one active enzyme dispersed within the pressure sensitive adhesive matrix.

A wide variety of substrates are suitable for use in the pressure sensitive adhesive articles of this disclosure. The substrate may be rigid, semi-rigid, or flexible. Examples of rigid substrates include glass plates, relatively thick polymeric plates such as plates of polycarbonate (PC) or polymethylmethacrylate (PMMA), ceramics, metal plates, or the external surface of device. Examples of semi-rigid substrates include relatively thick polymeric films (either monolithic films or multilayer films), thick metal foils, and the like. Examples of flexible substrates include tape backings, films (including both optical films and non-optical films), and release liners.

The choice of substrate can vary widely depending upon the desired use for the pressure sensitive adhesive article. In some embodiments, the pressure sensitive adhesive article is used in non-biological applications, such as optical applications involving optical films and optical substrates. In other embodiments, the pressure sensitive adhesive article is used in biological applications, such as in wound dressings, teeth whitening or plaque removal strips, and to prevent and/or remove biofilms from a surface, where the surface can be either a biological surface or an inanimate surface. Each of these embodiments has suitable types of substrates. In addition, other applications are also suitable for the pressure sensitive adhesive articles of this disclosure.

In some embodiments, the pressure sensitive adhesive article may be used to make optical articles or optical elements. As used herein, the term “optical element” refers to an article that has an optical effect or optical application. The optical elements can be used, for example, in electronic displays, architectural applications, transportation applications, projection applications, photonics applications, and graphics applications. Suitable optical elements include, but are not limited to, screens or displays, touch panels, cathode ray tubes, polarizers, reflectors, and the like.

Any suitable optical film can be used in the articles. As used herein, the term “optical film” refers to a film that can be used to produce an optical effect. The optical films are typically polymer-containing films that can be a single layer or multiple layers. The optical films are flexible and can be of any suitable thickness. The optical films often are at least partially transmissive, reflective, antireflective, polarizing, optically clear, or diffusive with respect to some wavelengths of the electromagnetic spectrum (e.g., wavelengths in the visible, ultraviolet, or infrared regions of the electromagnetic spectrum). Exemplary optical films include, but are not limited to, visible mirror films, color mirror films, solar reflective films, infrared reflective films, ultraviolet reflective films, brightness enhancement films, reflective polarizer films such as dual brightness enhancement films, absorptive polarizer films, optically clear films, tinted films, and antireflective films.

Some optical films have multiple layers such as multiple layers of polymer-containing materials (e.g., polymers with or without dyes) or multiple layers of metal-containing material and polymeric materials. Some optical films have alternating layers of polymeric material with different indexes of refraction. Other optical films have alternating polymeric layers and metal-containing layers. Exemplary optical films are described in the following patents: U.S. Pat. No. 6,049,419 (Wheatley et al.); U.S. Pat. No. 5,223,465 (Wheatley et al.); U.S. Pat. No. 5,882,774 (Jonza et al.); U.S. Pat. No. 6,049,419 (Wheatley et al.); U.S. Pat. No. RE 34,605 (Schrenk et al.); U.S. Pat. No.

5,579,162 (Bjornard et al.); and U.S. Pat. No. 5,360,659 (Arends et al.).

Substrates in optical articles or optical elements can have a variety of functions such as, for example, providing flexibility, rigidity, strength or support, reflectivity, antireflectivity, polarization, or transmissivity (e.g., selective with respect to different wavelengths). That is, the substrate can be flexible or rigid; reflective or non-reflective; visibly clear; colored but transmissive, or opaque (e.g., not transmissive); and polarizing or non-polarizing.

Exemplary substrates include, but are not limited to, the outer surface of an electronic display such as liquid crystal display or a cathode ray tube, the outer surface of a window or glazing, the outer surface of an optical component such as a reflector, polarizer, diffraction grating, mirror, touch panel, or lens, another film such as a decorative film or another optical film, or the like.

Representative examples of polymeric substrates include those that contain polyesters (e.g., polyethylene terephthalates and polyethylene naphthalates), polycarbonates, poly(meth)acrylates (e.g., polymethyl methacrylates), polyurethanes, polyvinyl alcohols, polyolefins such as polyethylenes and polypropylenes, polyvinyl chlorides, polyimides, cellulose triacetates, acrylonitrile-butadiene-styrene copolymers, and the like. In some embodiments the substrate comprises an optical film comprising polyester, polycarbonate, poly(meth)acrylate, polyurethane, polyolefin, or combinations or blends thereof.

In other embodiments, the pressure sensitive adhesive article is used in wound dressing applications. In these applications, the substrate is often a porous web. The porous web can act as a supporting layer or a carrier layer for the pressure sensitive adhesive layer or the porous web may act as a backing layer for the entire wound dressing article. Porous webs are desirable because they readily allow the passage of wound fluids, moisture vapor, and air. Hence, the porous webs are typically liquid permeable. A wide variety of materials may be used to prepare the porous web. Suitable materials are generally flexible, and may be fabric, non-woven or woven polymeric films, metallic, paper, and/or combinations thereof. For certain embodiments it may be desirable to use an open- or closed-cell foam, such as those disclosed in U.S. Pat. Nos. 6,548,727 and 5,409,472.

Suitable porous webs include knits, wovens (e.g., cheese cloth and gauze), nonwovens (including spun-bonded nonwovens), extruded porous sheets, and perforated sheets. The apertures (i.e., openings) in the porous webs are of sufficient size and sufficient number to facilitate high breathability. In some embodiments, the porous webs have at least 1 aperture per square centimeter. In some embodiments, the porous substrates have no greater than 225 apertures per square centimeter. In some embodiments, the apertures have an average opening size (i.e., the largest dimension of the opening) of at least 0.1 millimeter. In some embodiments, the apertures have an average opening size (i.e., the largest dimension of the opening) of no greater than 0.5 centimeter.

In some embodiments, the porous webs have a basis weight of at least 5 grams/meter². In some embodiments, the porous webs have a basis weight of no greater than 200 grams/meter².

The porous webs are generally flexible yet resistant to tearing. The thickness of the porous web is typically at least 0.0125 millimeter. In some embodiments, the thickness of the porous web is no greater than 4 millimeters.

The porous webs may be opaque or translucent or can come in a variety of different colors. Materials of the porous web may include a wide variety of materials including paper, natural or synthetic fibers, threads and yarns made from materials such as cotton, rayon, wool, hemp, jute, nylon, polyesters, polyacetates, polyacrylics, alginates, ethylene-propylene-diene rubbers, natural rubber, polyesters, polyisobutylenes, polyolefins (e.g., polypropylene polyethylene, ethylene propylene copolymers, and ethylene butylene copolymers), polyurethanes (including polyurethane foams), vinyls including polyvinylchloride and ethylene-vinyl acetate, polyamides, polystyrenes, fiberglass, ceramic fibers, and/or combinations thereof.

Additionally, as mentioned above, the pressure sensitive adhesive articles of this disclosure can be used to prevent and/or remove biofilms. Enzymes can interfere, disrupt, remove, inhibit or disenable the signal molecule(s) used in the sensing mechanism by microorganism to form biofilms and/or decompose extracellular polymeric substances (EPS). The EPS-decomposing enzyme may include carbohydrases (e.g., cellulose, glucanase) and protease (e.g., aminopeptidase, elastase) that can decompose polysaccharides and proteins respectively, which are main ingredients of EPS. Cellulase cleaves 1,4-beta-D-glycosidic bonding of cellulose, glucanase decomposes glucane, which is a polysaccharide secreted by microorganisms, aminopeptidase hydrolyzes the terminal peptide bond at the amino end of a polypeptide, and elastase decomposes elastine or a collagen ingredient, thereby disintegrating the EPS matrix of the biofilm. A number of references describe the use of enzymes to prevent or remove biofilms, including US Patent Publication Nos. 2007/0264715 (Robinson et al.) and 2009/0159533 (Lee et al.) and U.S. Pat. No. 7,494,810 (Kuhner et al.). Pressure sensitive adhesive articles of this disclosure can thus be used in medical and dental articles besides wound dressings, such as for example in teeth whitening or plaque removal strips, and to prevent and/or remove biofilms from a variety of inanimate surfaces such as keyboards, touch panels, toilet surfaces, and the like. These articles can be used in a variety of settings, in industrial settings, homes, hospitals, and the like. Articles that are used to prevent and/or remove biofilms from inanimate surfaces are sometimes referred to as “surface strips”. The surface strips can be adhered to the surface temporarily to remove biofilms, or they can remain adhered to a surface for extended periods of time to prevent the fonnation of on the surface.

The pressure sensitive adhesive articles of this disclosure also comprise a pressure sensitive adhesive matrix. A wide range of pressure sensitive adhesive matrices are suitable depending upon the specific use for which the pressure sensitive adhesive is to be employed. Typically the pressure sensitive adhesive matrix comprises at least one of a polyurea pressure sensitive adhesive polymer, a block copolymer pressure sensitive adhesive polymer, a silicone pressure sensitive adhesive polymer, or a (meth)acrylate-based pressure sensitive adhesive polymer.

Polyurea pressure sensitive adhesives useful in this disclosure include, for example, those disclosed in WO 00/75210 (Kinning et al.) and in U.S. Patent Publication No. 2011/0123800 (Sherman et al.). These polyurea pressure sensitive adhesives are generally free of silicone repeat units, and typically include poly alkylene oxide repeat units.

Block copolymer pressure sensitive adhesives generally comprise elastomers of the A-B or A-B-A type, where A represents a thermoplastic polystyrene block and B represents a rubbery block of polyisoprene, polybutadiene, or poly(ethylene/butylene), and resins. Examples of the various block copolymers useful in block copolymer pressure sensitive adhesives include linear, radial, star and tapered styrene-isoprene block copolymers such as “KRATON D1107P”, available from Shell Chemical Co., and “EUROPRENE SOL TE 9110”, available from EniChem Elastomers Americas, Inc.; linear styrene-(ethylene-butylene) block copolymers such as “KRATON G1657”, available from Shell Chemical Co.; linear styrene-(ethylene-propylene) block copolymers such as “KRATON G1750X”, available from Shell Chemical Co.; and linear, radial, and star styrene-butadiene block copolymers such as “KRATON D1118X”, available from Shell Chemical Co., and “EUROPRENE SOL TE 6205”, available from EniChem Elastomers Americas, Inc. The polystyrene blocks tend to form domains in the shape of spheroids, cylinders, or plates that causes the block copolymer pressure sensitive adhesives to have two-phase structures. Resins that associate with the rubber phase generally develop tack in the pressure sensitive adhesive. Examples of rubber phase associating resins include aliphatic olefin-derived resins, such as the “ESCOREZ 1300” series and the “WINGTACK” series, available from Goodyear; rosin esters, such as the “FORAL” series and the “STAYBELITE” Ester 10, both available from Hercules, Inc.; hydrogenated hydrocarbons, such as the “ESCOREZ 5000” series, available from Exxon; polyterpenes, such as the “PICCOLYTE A” series; and terpene phenolic resins derived from petroleum or terpentine sources, such as “PICCOFYN A100”, available from

Hercules, Inc. Resins that associate with the thermoplastic phase tend to stiffen the pressure sensitive adhesive. Thermoplastic phase associating resins include polyaromatics, such as the “PICCO 6000” series of aromatic hydrocarbon resins, available from Hercules, Inc.; coumarone-indene resins, such as the “CUMAR” series, available from Neville; and other high-solubility parameter resins derived from coal tar or petroleum and having softening points above about 85° C., such as the “AMOCO 18” series of alpha-methyl styrene resins, available from Amoco, “PICCOVAR 130” alkyl aromatic polyindene resin, available from Hercules, Inc., and the “PICCOTEX” series of alpha-methyl styrene/vinyltoluene resins, available from Hercules. Other materials can be added for special purposes, including rubber phase plasticizing hydrocarbon oils, such as, “TUFFLO 6056”, available from Lyondell Petrochemical Co., Polybutene-8 from Chevron, “KAYDOL”, available from Witco, and “SHELLFLEX 371”, available from Shell Chemical Co.; pigments; antioxidants, such as “IRGANOX 1010” and “IRGANOX 1076”, both available from Ciba-Geigy Corp., “BUTAZATE”, available from Uniroyal Chemical Co., “CYANOX LDTP”, available from American Cyanamid, and “BUTASAN”, available from Monsanto Co.; antiozonants, such as “NBC”, a nickel dibutyldithiocarbamate, available from DuPont; liquid rubbers such as “VISTANEX LMMH” polyisobutylene rubber; and ultraviolet light inhibitors, such as “IRGANOX 1010” and “TINUVIN P”, available from Ciba-Geigy Corp.

Silicone pressure sensitive adhesives typically comprise two major components, a polymer or gum, and a tackifying resin. The polymer is typically a high molecular weight polydimethylsiloxane or polydimethyldiphenylsiloxane, that contains residual silanol functionality (SiOH) on the ends of the polymer chain, or a block copolymer comprising polydiorganosiloxane soft segments and urea or oxamide terminated hard segments. The tackifying resin is generally a three-dimensional silicate structure that is endcapped with trimethylsiloxy groups (OSiMe₃) and also contains some residual silanol functionality. Examples of tackifying resins include SR 545, from General Electric Co., Silicone Resins Division, Waterford, N.Y., and MQD-32-2 from Shin-Etsu Silicones of America, Inc., Torrance, Calif Manufacture of typical silicone pressure sensitive adhesives is described in U.S. Pat. No. 2,736,721 (Dexter). Manufacture of silicone urea block copolymer pressure sensitive adhesive is described in U.S. Pat. No. 5,214,119 (Leir, et al). Other materials can be added for special purposes, including pigments, plasticizers, and fillers. Fillers are typically used in amounts from 0 parts to 10 parts per 100 parts of silicone pressure sensitive adhesive. Examples of fillers that can be used include zinc oxide, silica, carbon black, pigments, metal powders and calcium carbonate. One particularly suitable class of siloxane-containing pressure sensitive adhesives are those with oxamide terminated hard segments such as those described in U.S. Pat. No. 7,981,995 (Hays) and U.S. Pat. No. 7,371,464 (Sherman).

(Meth)acrylate pressure sensitive adhesives generally have a glass transition temperature of about 0° C. or less and may comprise from 100 to 80 weight percent of a C₃-C₁₂ alkyl ester component such as, for example, isooctyl acrylate, 2-ethylhexyl acrylate and n-butyl acrylate and from 0 to 20 weight percent of a polar component such as, for example, acrylic acid, methacrylic acid, ethylene-vinyl acetate units, N-vinylpyrrolidone, and styrene macromer. Generally, the acrylic pressure sensitive adhesives comprise from 0 to 20 weight percent of acrylic acid and from 100 to 80 weight percent of isooctyl acrylate. The acrylic pressure sensitive adhesives may be self-tacky or tackified. Useful tackifiers for acrylics are rosin esters such as “FORAL 85”, available from Hercules, Inc., aromatic resins such as “PICCOTEX LC-55WK”, aliphatic resins such as “PICCOTAC 95”, available from Hercules, Inc., and terpene resins such as α-pinene and β-pinene, available as “PICCOLYTE A-115” and “ZONAREZ B-100” from Arizona Chemical Co. Other materials can be added for special purposes, including hydrogenated butyl rubber, pigments, and curing agents to vulcanize the adhesive partially.

One class of pressure sensitive adhesives that is particularly suitable are optically clear adhesives. In some embodiments, the optically clear adhesive has a % Transmission of 95% or greater, or even 99% or greater. Also, in some embodiments, the optically clear adhesive has a haze value of 3% or less, or even 1% or less. In some embodiments, the optically clear adhesive has a clarity value of 99% or greater. In some embodiments, the adhesive is an optically clear pressure sensitive adhesive. The pressure sensitive adhesive component can be a single pressure sensitive adhesive or the pressure sensitive adhesive can be a combination of two or more pressure sensitive adhesives.

Optically clear pressure sensitive adhesives useful in the present disclosure include, for example, those based on a polyurea pressure sensitive adhesive polymer, a block copolymer pressure sensitive adhesive polymer, a silicone pressure sensitive adhesive polymer, or a (meth)acrylate-based pressure sensitive adhesive polymer, as described above.

In some embodiments where optical clarity is desired, the pressure sensitive adhesive articles of this disclosure are optically clear. This means that the substrate chosen is optically clear, the pressure sensitive adhesive matrix is optically clear, and the active enzyme dispersed within the pressure sensitive adhesive matrix does not hinder the optical clarity of the pressure sensitive adhesive article. In other embodiments, optical clarity is not desired, and a wider range of substrates and pressure sensitive adhesive matrices are suitable.

The pressure sensitive adhesive articles of this disclosure also comprise at least one active enzyme. A wide range of active enzymes are suitable. Typically the active enzyme comprises at least one of amidases, carbohydrases, cellulases, deaminases, esterases, lipases, phospholipases, nucleases, oxidoreductases, peroxidases, proteases, carboxypeptidases, thiol reductase, acylases, aminocyclases, elastase, lactonases, or lysozyme. Combinations of active enzymes are also possible. In some embodiments, the active enzyme remains active for at least 1 month at ambient temperature. In other embodiments, the active enzyme remains active for at least 6 months at ambient temperature, or even one year or longer at ambient temperature.

The amount of added active enzyme can be varied as desired. Typically the active enzyme is dispersed into the pressure sensitive adhesive matrix in quantities ranging from 0.1 to 2.0 weight % based on the total weight of the pressure sensitive adhesive matrix

Additionally, it may desirable in some embodiments to utilize a carrier agent to disperse the active enzyme and then to disperse the carrier agent/enzyme composition in the pressure sensitive adhesive matrix. Examples of particularly suitable carrier agents include polyethylene glycols and functionalized polyethylene glycols such as acrylate functional polyethylene glycols. Examples of suitable carrier agents include PEG 200 commercially available from Alfa Aesar, Ward Hill, Mass. and polyethylene glycol (200) diacrylate, or PEG(200)DA, commercially available as SR259 from Sartomer, Exton, Pa.

In addition to the active enzymes, the pressure sensitive adhesive articles of this disclosure may also include one or more optional additives as long as the optional additive does not interfere with the desired adhesive properties or with the activity of the enzyme. Examples of suitable additives include tackifying resins, plasticizing resins, antioxidants, and combinations thereof.

In embodiments with a silicone pressure sensitive adhesive matrix, silicone tackifying resins are frequently added. Examples of silicone tackifying resins include the commercially available MQ resins. In many embodiments a plasticizing resin is added to the pressure sensitive adhesive matrix. Many of these plasticizing resins are liquids, with isopropyl myristate being a particularly suitable plasticizing resin.

As mentioned above, the pressure sensitive adhesive articles of this disclosure have properties which are unaffected by the dispersed active enzyme. By this it is meant that the desired properties of a pressure sensitive adhesive article that contains the dispersed active enzyme is essentially the same as the same pressure sensitive adhesive article that does not contain the dispersed active enzyme. In particular, two desired properties have been studied, optical properties and peel adhesion.

Optical properties have been discussed above in conjunction with the choice of backings and pressure sensitive adhesive matrix. Therefore, two pressure sensitive adhesive articles that contain the same optically clear substrate and the same optically clear pressure sensitive adhesive matrix, where one of the pressure sensitive adhesive articles contains active enzyme dispersed within the pressure sensitive adhesive matrix will have essentially the same optical properties.

Similarly, two pressure sensitive adhesive articles that contain the same substrate and the same pressure sensitive adhesive matrix, where one of the pressure sensitive adhesive articles contains active enzyme dispersed within the pressure sensitive adhesive matrix, will have essentially the same 180° Peel Adhesion to a glass substrate. The test for 180° Peel Adhesion to a glass substrate is described in detail in the Examples section, and is based upon the standard test method ASTM D 3330-90 modified with a glass substrate instead of a stainless steel one. 180° Peel Adhesion to a glass substrate is a material property of the pressure sensitive adhesive article itself, and is not a process variable. In other words, the standard test is run to determine the property of 180° Peel Adhesion to a glass substrate, but this is merely the means used to determine the material property of the adhesive article, and does not imply that adhesion of the articles to a glass substrate is a process limitation for the articles. As will be shown below, the articles of this disclosure may be adhered to a wide range of substrates, and the pressure sensitive adhesive article itself need not be adhered to any substrate to be part of this disclosure.

Also disclosed herein are adhesive laminates. The adhesive laminates comprise a first substrate, a second substrate, and a layer of pressure sensitive adhesive in contact with the first substrate and the second substrate. The pressure sensitive adhesive layer comprises a pressure sensitive adhesive matrix, and at least one active enzyme dispersed within the pressure sensitive adhesive matrix. If a carrier agent is used, the adhesive laminate also comprises a carrier agent.

The first and second substrates include a wide range of substrate types. The substrates may be rigid, semi-rigid, or flexible. Examples of rigid substrates include glass plates, relatively thick polymeric plates such as plates of polycarbonate (PC) or polymethylmethacrylate (PMMA), ceramics, metal plates, or the external surface of device. Examples of semi-rigid substrates include relatively thick polymeric films (either monolithic films or multilayer films), thick metal foils, and the like. Examples of flexible substrates include tape backings, films (including both optical films and non-optical films), and release liners. Additionally, in the instances where the laminate includes a wound dressing article, the first substrate can be human skin, in embodiments where the pressure sensitive adhesive layer is a teeth whitening strip or plaque removal strip, the first substrate can be human teeth, and in embodiments where the pressure sensitive adhesive layer is a surface strip, the first substrate can be wide variety of inanimate surfaces, as described above. In teeth whitening embodiments, the active enzyme is often an oxidoreductase, a peroxidase, or a combination thereof.

The laminates may be prepared from the pressure sensitive adhesive articles described above, for example by laminating the pressure sensitive adhesive article to a substrate. The laminates may also be prepared by coating or laminating a pressure sensitive adhesive layer to a substrate surface and then laminating another substrate to the pressure sensitive adhesive layer. These methods are described in greater detail below.

In some embodiments, the adhesive laminate is optically clear. In these embodiments, the first and second substrates are optically clear and the adhesive matrix is also optically clear. Examples of such laminates include ones comprising: rigid substrate/pressure sensitive adhesive layer/film substrate; rigid substrate/pressure sensitive adhesive layer/rigid substrate; and film substrate/pressure sensitive adhesive layer/film substrate. In these laminates, the rigid substrate or substrates can be, for example glass, polycarbonate, poly methyl methacrylate, or the like, and the film substrates can be optical films. Examples of these types of substrates are described above.

In other embodiments, the adhesive laminate comprises a wound dressing. In these embodiments the first substrate is human skin with a wound, and the adhesive layer and second substrate comprise a wound dressing article. In these embodiments, the second substrate is typically a tape backing type of substrate and may be porous or nonporous. As mentioned above, the enzymes dispersed in the pressure sensitive adhesive layer can aid in wound debridement and also aid in preventing biofilm formation.

In embodiments where the adhesive laminate comprises a teeth whitening or plaque removal strip, the first substrate comprises human teeth, and the adhesive layer and second substrate comprise a teeth whitening or plaque removal strip article. In these embodiments, the second substrate is typically a film. As mentioned above, the enzymes dispersed in the pressure sensitive adhesive layer can aid in biofilm removal such as plaque.

In embodiments where the adhesive laminate comprises a surface strip, the first substrate comprises an inanimate surface, and the adhesive layer and second substrate comprise a surface strip article. In these embodiments, the second substrate is typically a film. As mentioned above, the enzymes dispersed in the pressure sensitive adhesive layer can aid in biofilm prevention and/or removal from surfaces.

Also disclosed are methods for preparing pressure sensitive adhesive articles and laminates. The methods comprise providing a first substrate with a first major surface and a second major surface, providing a pressure sensitive adhesive or a pressure sensitive adhesive precursor mixture composition, contacting the pressure sensitive adhesive or pressure sensitive adhesive precursor mixture composition to the first major surface of the first substrate, and forming the pressure sensitive adhesive or pressure sensitive adhesive precursor mixture composition into a pressure sensitive adhesive layer. The pressure sensitive adhesive layer or pressure sensitive adhesive precursor mixture composition comprises a polymeric matrix or pre-polymeric reactive mixture, and at least one active enzyme dispersed within the polymeric matrix or pre-polymeric reactive mixture.

In some embodiments, the step of providing a pressure sensitive adhesive or a pressure sensitive adhesive precursor mixture composition comprises mixing a pressure sensitive adhesive polymer or pressure sensitive adhesive pre-polymer composition with an active enzyme. This mixing may be achieved in a variety of ways. In some embodiments the components are simply mixed at ambient temperature, in other embodiments a dispersing medium is added to facilitate mixing, and in yet other embodiments heat is applied to facilitate mixing. For example, in some embodiments, the pressure sensitive adhesive polymer or pressure sensitive adhesive pre-polymer composition is mixed with a solution of active enzyme in water.

Forming of the pressure sensitive adhesive layer from the pressure sensitive adhesive or pressure sensitive adhesive precursor mixture composition can be achieved in a variety of different ways involving one process or a combination of processes, depending upon the nature of the pressure sensitive adhesive or pressure sensitive adhesive precursor mixture composition. The process can include curing, drying, cooling, allowing the pressure sensitive adhesive to dwell at room temperature, or a combination thereof. The formed pressure sensitive adhesive layer comprises a pressure sensitive adhesive matrix with at least one active enzyme dispersed within the pressure sensitive adhesive matrix.

In embodiments where the pressure sensitive adhesive layer is formed from a pressure sensitive adhesive, the pressure sensitive adhesive can be contacted to the first major surface of the first substrate as a solution, dispersion, or a 100% solids composition. In embodiments where the pressure sensitive adhesive is a solution or dispersion, the solvent or dispersing medium is removed either by the application of heat or by allowing the pressure sensitive adhesive to dwell at room temperature for sufficient time to allow the solvent or dispersing medium to evaporate. In embodiments where the pressure sensitive adhesive is a 100% solids composition, the composition is often applied to the first major surface of the first substrate as a molten or heated mixture. In these embodiments, the composition may be cooled to form the pressure sensitive adhesive layer, or the composition may be allowed to dwell at room temperature for sufficient time to allow the composition to achieve ambient temperature.

In embodiments where the pressure sensitive adhesive layer is formed from a pressure sensitive adhesive precursor mixture composition, the precursor composition is cured. This curing can take a variety of forms depending upon the nature of the precursor mixture. Typically curing is initiated through the use of an initiator and the application of energy to activate the initiator. The application of energy can involve the application of heat or exposure to radiation, such as UV light.

In some embodiments, the at least one active enzyme dispersed within the polymeric matrix or pre-polymeric reactive mixture further comprises water. Typically the enzymes are supplied in water or are placed in water prior to dispersing them within the polymeric matrix or pre-polymeric reactive mixture. Generally, the water is transient, meaning that it may not be present in the final pressure sensitive adhesive layer. In some instances, traces of water may remain in the final pressure sensitive adhesive layer, but the presence of water is not necessary for the activity of the enzyme, or for the stability of the enzyme.

In some embodiments, it may be desirable to utilize a carrier agent along with the active enzyme. In these embodiments, rather than directly dispersing the active enzyme within the polymeric matrix or pre-polymeric reactive mixture, the active enzyme can be pre-mixed with the carrier agent prior to dispersing within the polymeric matrix or pre-polymeric reactive mixture. In other words, a mixture is formed from the active enzyme and the carrier agent, and this mixture is dispersed within the polymeric matrix or pre-polymeric reactive mixture. Examples of suitable carrier agents include polyethylene glycols and functionalized polyethylene glycols such as acrylate functional polyethylene glycols. Examples of particularly suitable carrier agents include PEG 200 commercially available from Alfa Aesar, Ward Hill, Mass. and polyethylene glycol (200) diacrylate, or PEG(200)DA, commercially available as SR259 from Sartomer, Exton, Pa.

As was stated previously, one advantage of the pressure sensitive adhesives of this disclosure is that the presence of the active enzymes within the pressure sensitive adhesive matrix is able to break down and digest organic residues. Thus, in some embodiments the first major surface of the first substrate comprises organic contamination or wherein upon contacting the first major surface of the first substrate with the pressure sensitive adhesive or pressure sensitive adhesive precursor mixture composition bubbles form at the interface, such that the organic contamination or bubbles are visible to the naked eye after forming the pressure sensitive adhesive layer. In these embodiments, the organic contamination or bubbles visible to the naked eye are not visible to the naked eye after the construction comprising the first substrate and pressure sensitive adhesive layer has dwelled at room temperature for a period of time. In other words, when the construction comprising the first substrate and pressure sensitive adhesive layer is formed the organic contamination or bubbles are visible to the naked eye, but disappear over a period of time. This period of time can vary over a broad range of from 24 hours to 2 weeks, depending upon a number of factors.

The method further comprises the making of adhesive laminates. In general there are two ways to form laminates of the type: first substrate/PSA layer/second substrate. In the first way, a pressure sensitive adhesive article comprising a substrate (the first substrate) and a layer of pressure sensitive adhesive can be laminated to the surface of the second substrate. In the second way, a pressure sensitive adhesive layer is contacted to the surface of the first or second substrate and then the second or first substrate is laminated to the pressure sensitive adhesive surface. The contacting of the pressure sensitive adhesive layer to the surface of the substrate may be coating of a pressure sensitive adhesive or a precursor mixture that upon curing forms the pressure sensitive adhesive to the substrate surface, or the adhesive layer can be supplied on a release liner, laminated to the substrate surface, and then the release liner is removed to expose the surface of the pressure sensitive adhesive layer. The other substrate is then laminated to the exposed surface of the pressure sensitive adhesive layer. Any of these techniques can be used to form the adhesive laminates of the present disclosure.

In embodiments where the adhesive laminates are formed by lamination of a pressure sensitive adhesive article to a substrate (the second substrate), the pressure sensitive adhesive article can be any of the pressure sensitive adhesive articles described above. The second substrate can be any of the substrates described above, and can also be human skin, human teeth, gums, and the like.

In some embodiments, the pressure sensitive adhesive layer is laminated to the surface of the first substrate and then the second substrate is laminated to the pressure sensitive adhesive surface or conversely, the pressure sensitive adhesive surface can be laminated to the second substrate surface. The pressure sensitive adhesive layer comprises a pressure sensitive adhesive matrix with at least one active enzyme dispersed therein. Suitable pressure sensitive adhesive matrices and active enzymes are described above. The second substrate, like the first substrate, may contain organic contaminants that are removed by the active enzymes of the pressure sensitive adhesive layer.

In some of these embodiments, the pressure sensitive adhesive layer is supplied on a release liner (i.e. the first substrate comprises a release liner), that is laminated to the surface of the first substrate and the release liner is removed to expose the pressure sensitive adhesive layer. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like). At least some release liners are coated with a layer of a release agent such as a silicone-containing material or a fluorocarbon-containing material. Exemplary release liners include, but are not limited to, liners commercially available from CP Film (Martinsville, Va.) under the trade designation “T-30” and “T-10” that have a silicone release coating on polyethylene terephthalate film. The liner can have a microstructure on its surface that is imparted to the adhesive to form a microstructure on the surface of the adhesive layer. The liner can then be removed to expose an adhesive layer having a microstructured surface.

In other of these embodiments, the pressure sensitive adhesive layer or a precursor mixture which upon curing forms the pressure sensitive adhesive layer is coated on the surface of the first substrate. If desired or needed, the coating can be dried and/or cured to form the pressure sensitive adhesive layer. In these embodiments, the pressure sensitive adhesive layer comprises a pressure sensitive adhesive matrix with at least one active enzyme dispersed therein. Typically, the pressure sensitive adhesive itself is coated on the surface of the first substrate. In many embodiments, the pressure sensitive adhesive matrix with the enzyme dispersed therein is coated as a mixture comprising the pressure sensitive adhesive matrix, the enzyme, and one or more liquid components, typically water. The mixture may contain additional optional additives such as tackifying agents, plasticizing agents, and the like. The coated mixture is typically dried by exposure to elevated temperature to produce the coated pressure sensitive adhesive layer.

As described above, a wide variety of substrates are suitable for the first and second substrates. The substrates may be rigid, semi-rigid, or flexible. Examples of rigid substrates include glass plates, relatively thick polymeric plates such as plates of polycarbonate (PC) or polymethylmethacrylate (PMMA), ceramics, metal plates, or the external surface of device. Examples of semi-rigid substrates include relatively thick polymeric films (either monolithic films or multilayer films), thick metal foils, and the like. Examples of flexible substrates include tape backings, films (including both optical films and non-optical films), and release liners. Examples of the laminates thus formed have been described in detail above. In some particularly suitable embodiments, the first substrate comprises a film or tape backing, and the second substrate comprises a rigid or semi-rigid substrate. In other particularly suitable embodiments, both of the first and second substrates comprise a film or tape backing.

The methods of the present disclosure are particularly suitable for preparing optical articles. Therefore, in some embodiments the laminate articles formed comprise an optically clear article. Therefore, the first and second substrates are optically clear, and the pressure sensitive adhesive matrix is also optically clear. The pressure sensitive adhesive layers described herein are well adapted for use in such laminates because the presence of the active enzymes in the pressure sensitive adhesive matrix does not interfere with the optical properties of the pressure sensitive adhesive matrix, and the active enzymes are able to break down and digest organic residues present on one or both substrate surfaces.

Thus, if the first major surface of the second substrate comprises organic contamination or if upon contacting the first major surface of the second substrate with the pressure sensitive adhesive layer bubbles form at the interface, such that the organic contamination or bubbles are visible to the naked eye after forming the laminate article, the organic contamination or bubbles visible to the naked eye are not visible to the naked eye after the laminate has dwelled for a period of time at room temperature. In other words, when the laminate construction comprising the first substrate, the pressure sensitive adhesive layer, and the second substrate is formed, the organic contamination or bubbles are visible to the naked eye, but disappear over a period of time. This period of time can vary over a broad range of from 24 hours to 2 weeks, depending upon a number of factors.

This disclosure includes the following embodiments:

Among the embodiments are pressure sensitive adhesive articles, Embodiment 1 includes a pressure sensitive adhesive article comprising: a substrate; and a layer of pressure sensitive adhesive in contact with the substrate, wherein the pressure sensitive adhesive layer comprises: a pressure sensitive adhesive matrix; and at least one active enzyme dispersed within the pressure sensitive adhesive matrix.

Embodiment 2 is the pressure sensitive adhesive article of embodiment 1, wherein the pressure sensitive adhesive matrix comprises at least one of a polyurea pressure sensitive adhesive polymer, a block copolymer pressure sensitive adhesive polymer, a silicone pressure sensitive adhesive polymer, or a (meth)acrylate-based pressure sensitive adhesive polymer.

Embodiment 3 is the pressure sensitive adhesive article of embodiment 1 or 2, wherein the pressure sensitive adhesive article is optically clear.

Embodiment 4 is the pressure sensitive adhesive article of any of embodiments 1-3, wherein the active enzyme comprises at least one of amidases, carbohydrases, cellulases, deaminases, esterases, lipases, phospholipases, nucleases, oxidoreductases, peroxidases, proteases, carboxypeptidases, thiol reductase, acylases, aminocyclases, elastase, lactonases, or lysozyme.

Embodiment 5 is the pressure sensitive adhesive article of any of embodiments 1-4, wherein the substrate comprises a rigid substrate, a tape backing, an optical film, or a release liner.

Embodiment 6 is the pressure sensitive adhesive article of embodiment 5, wherein the substrate comprises an optical film comprising polyester, polycarbonate, poly(meth)acrylate, polyurethane, polyolefin, or combinations or blends thereof.

Embodiment 7 is the pressure sensitive adhesive article of any of embodiments 1-6, wherein the active enzyme remains active for at least 1 month at ambient temperature.

Embodiment 8 is the pressure sensitive adhesive article of any of embodiments 1-6, wherein the active enzyme remains active for at least 6 months at ambient temperature.

Embodiment 9 is the pressure sensitive adhesive article of any of embodiments 1-6, wherein the active enzyme remains active for at least 12 months at ambient temperature.

Embodiment 10 is the pressure sensitive adhesive article of any of embodiments 1-6, wherein the active enzyme remains active for greater than 12 months at ambient temperature.

Embodiment 11 is the pressure sensitive adhesive article of any of embodiments 1-10, wherein the 180° Peel Adhesion to a glass substrate is unchanged from the 180° Peel Adhesion to a glass substrate of the same pressure sensitive adhesive matrix without the presence of the active enzyme.

Embodiment 12 is the pressure sensitive adhesive article of any of embodiments 1-11, further comprising a carrier agent dispersed within the pressure sensitive adhesive matrix.

Embodiment 13 is the pressure sensitive adhesive article of any of embodiments 1-12, wherein the pressure sensitive adhesive matrix further comprises at least one additive.

Embodiment 14 is the pressure sensitive adhesive article of embodiment 13, wherein the at least one additive comprises a tackifying resin, a plasticizing resin, an antioxidant, or a combination thereof.

Embodiment 15 is the pressure sensitive adhesive article of any of embodiments 1-14, wherein the pressure sensitive adhesive article comprises a wound dressing.

Embodiment 16 is the pressure sensitive adhesive article of any of embodiments 1-14, wherein the pressure sensitive adhesive article comprises a teeth whitening or plaque removal strip.

Embodiment 17 is the pressure sensitive adhesive article of any of embodiments 1-14, wherein the pressure sensitive adhesive article comprises a surface strip.

Also disclosed are adhesive laminates. Embodiment 18 includes an adhesive laminate comprising: a first substrate; a second substrate; and a layer of pressure sensitive adhesive in contact with the first substrate and the second substrate, wherein the pressure sensitive adhesive layer comprises: a pressure sensitive adhesive matrix; and at least one active enzyme dispersed within the pressure sensitive adhesive matrix.

Embodiment 19 is the adhesive laminate of embodiment 18, wherein the pressure sensitive adhesive matrix comprises at least one of a polyurea pressure sensitive adhesive polymer, a block copolymer pressure sensitive adhesive polymer, a silicone pressure sensitive adhesive polymer, or a (meth)acrylate-based pressure sensitive adhesive polymer.

Embodiment 20 is the adhesive laminate of embodiment 18 or 19, wherein the adhesive laminate is optically clear.

Embodiment 21 is the adhesive laminate of any of embodiments 18-20, wherein the active enzyme comprises at least one of amidases, carbohydrases, cellulases, deaminases, esterases, lipases, phospholipases, nucleases, oxidoreductases, peroxidases, proteases, carboxypeptidases, thiol reductase, acylases, aminocyclases, elastase, lactonases, or lysozyme.

Embodiment 22 is the adhesive laminate of any of embodiments 18-21, wherein each of the first substrate and the second substrate comprises a rigid substrate, a tape backing, an optical film, or a release liner.

Embodiment 23 is the adhesive laminate of embodiment 22, wherein the second substrate comprises an optical film comprising polyester, polycarbonate, poly(meth)acrylate, polyurethane, polyolefin, or combinations or blends thereof.

Embodiment 24 is the adhesive laminate of any of embodiments 18-21, wherein the first substrate comprises a tape backing and the second substrate comprises human skin.

Embodiment 25 is the adhesive laminate of any of embodiments 18-21, wherein the first substrate comprises a tape backing or film, and the second substrate comprises human teeth.

Embodiment 26 is the adhesive laminate of any of embodiments 18-25, wherein the active enzyme remains active for at least 1 month at ambient temperature.

Embodiment 27 is the adhesive laminate of any of embodiments 18-25, wherein the active enzyme remains active for at least 6 months at ambient temperature.

Embodiment 28 is the adhesive laminate of any of embodiments 18-25, wherein the active enzyme remains active for at least 12 months at ambient temperature.

Embodiment 29 is the pressure sensitive adhesive article of any of embodiments 18-25, wherein the active enzyme remains active for greater than 12 months at ambient temperature.

Embodiment 30 is the pressure sensitive adhesive article of any of embodiments 18-29, further comprising a carrier agent dispersed within the pressure sensitive adhesive matrix.

Embodiment 31 is the pressure sensitive adhesive article of any of embodiments 18-30, wherein the pressure sensitive adhesive matrix further comprises at least one additive.

Embodiment 32 is the pressure sensitive adhesive article of embodiment 31, wherein the at least one additive comprises a tackifying resin, a plasticizing resin, an antioxidant, or a combination thereof.

Also disclosed are methods of making adhesive articles. Embodiment 33 includes a method of making an adhesive article, comprising: providing a first substrate with a first major surface and a second major surface; providing a pressure sensitive adhesive or a pressure sensitive adhesive precursor mixture composition; contacting the pressure sensitive adhesive or pressure sensitive adhesive precursor mixture composition to the first major surface of the first substrate; and forming the pressure sensitive adhesive or pressure sensitive adhesive precursor mixture composition into a pressure sensitive adhesive layer, wherein the pressure sensitive adhesive layer or pressure sensitive adhesive precursor mixture composition comprises: a polymeric matrix or pre-polymeric reactive mixture; and at least one active enzyme dispersed within the polymeric matrix or pre-polymeric reactive mixture.

Embodiment 34 is the method of embodiment 33, wherein the at least one active enzyme dispersed within the polymeric matrix or pre-polymeric reactive mixture further comprises water.

Embodiment 35 is the method of embodiment 33 or 34, wherein forming the pressure sensitive adhesive or pressure sensitive adhesive precursor mixture composition into a pressure sensitive adhesive layer, comprises curing, drying, cooling, allowing the pressure sensitive adhesive to dwell at room temperature, or a combination thereof, such that a layer is formed comprising a pressure sensitive adhesive matrix with at least one active enzyme dispersed within the pressure sensitive adhesive matrix.

Embodiment 36 is the method of any of embodiments 33-35, wherein providing a pressure sensitive adhesive or a pressure sensitive adhesive precursor mixture composition comprises mixing a pressure sensitive adhesive polymer or pressure sensitive adhesive pre-polymer composition with an active enzyme.

Embodiment 37 is the method of any of embodiments 33-35, wherein providing a pressure sensitive adhesive or a pressure sensitive adhesive precursor mixture composition comprises mixing a pressure sensitive adhesive polymer or pressure sensitive adhesive pre-polymer composition with a solution of active enzyme in water

Embodiment 38 is the method of any of embodiments 33-35, wherein providing a pressure sensitive adhesive or a pressure sensitive adhesive precursor mixture composition comprises forming a mixture of an active enzyme and a carrier agent and mixing the mixture of an active enzyme and a carrier agent with a pressure sensitive adhesive polymer or pressure sensitive adhesive pre-polymer composition.

Embodiment 39 is the method of embodiment 38, wherein the carrier agent comprises a polyethylene glycol or polyethylene glycol-acrylate.

Embodiment 40 is the method of any of embodiments 33-39, wherein the pressure sensitive adhesive matrix comprises at least one of a polyurea pressure sensitive adhesive polymer, a block copolymer pressure sensitive adhesive polymer, a silicone pressure sensitive adhesive polymer, or a (meth)acrylate-based pressure sensitive adhesive polymer.

Embodiment 41 is the method of any of embodiments 33-40, wherein the pressure sensitive adhesive article is optically clear.

Embodiment 42 is the method of any of embodiments 33-41, wherein the active enzyme comprises at least one of amidases, carbohydrases, cellulases, deaminases, esterases, lipases, phospholipases, nucleases, oxidoreductases, peroxidases, proteases, carboxypeptidases, thiol reductase, acylases, aminocyclases, elastase, lactonases, or lysozyme.

Embodiment 43 is the method of any of embodiments 33-42, wherein the first substrate comprises a rigid substrate, a tape backing, an optical film, or a release liner.

Embodiment 44 is the method of embodiment 43, wherein the first substrate comprises an optical film comprising polyester, polycarbonate, poly(meth)acrylate, polyurethane, polyolefin, or combinations or blends thereof.

Embodiment 45 is the method of any of embodiments 33-43, wherein the active enzyme remains active for at least 1 month at ambient temperature.

Embodiment 46 is the method of any of embodiments 33-43, wherein the active enzyme remains active for at least 6 months at ambient temperature.

Embodiment 47 is the method of any of embodiments 33-43, wherein the active enzyme remains active for at least 12 months at ambient temperature.

Embodiment 48 is the method of any of embodiments 33-43, wherein the active enzyme remains active for greater than 12 months at ambient temperature.

Embodiment 49 is the method of any of embodiments 33-48, wherein the pressure sensitive adhesive matrix has a 180° Peel Adhesion to a glass substrate is unchanged from the 180° Peel Adhesion to a glass substrate of the same pressure sensitive adhesive matrix pressure without the presence of the active enzyme.

Embodiment 50 is the method of any of embodiments 33-49, wherein the pressure sensitive adhesive matrix further comprises at least one additive.

Embodiment 51 is the method of embodiment 50, wherein the at least one additive comprises a tackifying resin, a plasticizing resin, an antioxidant, or a combination thereof

Embodiment 52 is the method of any of embodiments 33-51, wherein the first major surface of the first substrate comprises organic contamination or wherein upon contacting the first major surface of the first substrate with the pressure sensitive adhesive or pressure sensitive adhesive precursor mixture composition bubbles form at the interface, such that the organic contamination or bubbles are visible to the naked eye after forming the pressure sensitive adhesive layer.

Embodiment 53 is the method of embodiment 52, wherein the organic contamination or bubbles visible to the naked eye are not visible to the naked eye after the construction comprising the first substrate and pressure sensitive adhesive layer has dwelled at room temperature for 1 day.

Embodiment 54 is the method of embodiment 52, wherein the organic contamination or bubbles visible to the naked eye are not visible to the naked eye after the construction comprising the first substrate and pressure sensitive adhesive layer has dwelled at room temperature for 1 week.

Embodiment 55 is the method of embodiment 52, wherein the organic contamination or bubbles visible to the naked eye are not visible to the naked eye after the construction comprising the first substrate and pressure sensitive adhesive layer has dwelled at room temperature for 2 weeks.

Embodiment 56 is the method of any of embodiments 33-55, further comprising providing a second substrate with a first major surface and a second major surface and contacting the first major surface of the second substrate to the formed pressure sensitive adhesive layer to form a laminate article.

Embodiment 57 is the method of embodiment 56, wherein the second substrate comprises a rigid substrate, a tape backing, an optical film, or a release liner.

Embodiment 58 is the method of embodiment 56 or 57, wherein the formed laminate article is optically clear.

Embodiment 59 is the method of any of embodiments 56-58, wherein the first major surface of the second substrate comprises organic contamination or wherein upon contacting the first major surface of the second substrate with the pressure sensitive adhesive layer bubbles form at the interface, such that the organic contamination or bubbles are visible to the naked eye after forming the laminate article.

Embodiment 60 is the method of embodiment 59, wherein the organic contamination or bubbles visible to the naked eye are not visible to the naked eye after the construction comprising the first substrate and pressure sensitive adhesive layer has dwelled at room temperature for 1 day.

Embodiment 61 is the method of embodiment 59, wherein the organic contamination or bubbles visible to the naked eye are not visible to the naked eye after the construction comprising the first substrate and pressure sensitive adhesive layer has dwelled at room temperature for 1 week.

Embodiment 62 is the method of embodiment 59, wherein the organic contamination or bubbles visible to the naked eye are not visible to the naked eye after the construction comprising the first substrate and pressure sensitive adhesive layer has dwelled at room temperature for 2 weeks.

Embodiment 63 is the method of embodiment 56, wherein the second substrate comprises human skin and the first substrate and pressure sensitive adhesive layer comprise a wound dressing.

Embodiment 64 is the method of embodiment 63, wherein the wound dressing provides wound debridement, biofilm prevention, or a combination thereof.

Embodiment 65 is the method of embodiment 56, wherein the second substrate comprises human teeth and the first substrate and pressure sensitive adhesive layer comprise a teeth whitening strip, a plaque removal strip or a combination thereof.

Embodiment 66 is the method of embodiment 65, wherein the teeth whitening strip provides dental plaque removal, biofilm removal or a combination thereof.

Embodiment 67 is the method of embodiment 56, wherein the second substrate comprises an inanimate surface and the first substrate and pressure sensitive adhesive layer comprise a surface strip.

Embodiment 68 is the method of embodiment 67, wherein the surface strip provides biofilm prevention, biofilm removal or a combination thereof.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wisc. unless otherwise noted. The following abbreviations are used: cm=centimeters; nm=nanometers; m=meters; in=inch; kg=kilograms; min=minutes; h, hr, or hrs=hours; rpm=revolutions per minute; OD=Optical Density; M=molar; mM=millimolar; ml=milliliters; N=Newtons; dm=decimeters. The terms “weight %”, “% by weight”, and “wt %” are used interchangeably.

Table of Abbreviations

| Abbreviation or | |
|---|---|
| Trade | |
| Designation | Description |
| PU-PSA | Polyurea PSA, prepared as described in the Synthesis |
| | Examples below as Synthesis Example a). |
| MAcEPE | 8K (8,000 g/mol weight average molecular weight) |
| | methacrylated urea extended polyether as described |
| | in PCT Publication No. WO 2009/085662 |
| IPM | Isopropyl myristate commercially available as |
| | LIPONATE IPM from Lipo Chemical, Patterson, NJ. |
| PSA-1 | An acrylate polymer pressure sensitive adhesive |
| | as described in U.S. Pat. RE 24,906 (Ulrich). |
| PI-1 | Photoinitiator-1 commercially available as |
| | DAROCUR 4265 from BASF, Florham Park, NJ. |
| SIS-PSA | Styrene-isoprene-styrene pressure sensitive adhesive |
| | prepared as described in the Synthesis Examples |
| | below as Synthesis Example b). |
| SIS Polymer | Styrene-isoprene-styrene block copolymer commercially |
| | available as QUINTAC 3620 from Zeon Corporation; |
| | Tokyo, Japan. |
| SP-PSA | Silicone polyoxamide-based pressure sensitive adhesive |
| | prepared as described in the Synthesis Examples |
| | below as Synthesis Example c). |
| SP-Polymer | Silicone polyoxamide polymer of 20K (20,000 g/mol |
| | weight average molecular weight) described in, U.S. |
| | Pat. No. 7,371,464 (Sherman et al.), and U.S. Pat. |
| | No. 7,705,103 (Sherman et al.). |
| STR | Siloxane Tackifying Resin, commercially available as |
| | MQ resin SR545 from Momentive Chemical, Columbus, |
| | OH. |
| A-PSA | Acrylate-based pressure sensitive adhesive prepared |
| | as described in the Synthesis Examples below as |
| | Synthesis Example d). |
| PET Film | A 127 micrometer (5 mil) thick polyethylene- |
| | teraphthalate film. |
| PEG | Polyethylene glycol, commercially available as PEG |
| | 200 from Alfa Aesar, Ward Hill, MA. |
| PEG-A | Polyethylene glycol (200) diacrylate, or PEG(200)DA, |
| | commercially available as SR259 from Sartomer, Exton, |
| | PA. |
| NSLPN | N-succinyl-L-phenylalanine-p-nitroanilide |
| BAPNA | N-α-benzoyl-DL-arginine 4-nitroanilide hydrochloride |

### Synthesis Examples: Adhesive Formulations Used

a) Polyurea based PSA (PU-PSA): This is a urea-based pressure sensitive adhesive as described in example 11 of US Patent Publication No. 2011/0123800 (Sherman et al.). The adhesive contained 50% MAcEPE, 25% IPM, 25% PSA-1 and 2% PI-1.
b) Styrene Isoprene Styrene (SIS) block copolymer based PSA (SIS-PSA): Materials were used as received. To a clear jar, 7.5 grams of SIS Polymer, 2.5 grams of IPM, 16.7 grams of toluene and 1.9 grams of isopropyl alcohol were added. This solution was agitated until all components were dissolved.
c) Silicone based PSA (SP-PSA): This is a silicone polyoxamide-based pressure sensitive adhesive containing 90% SP-Polymer and 10% STR.
d) Acrylate based PSA (A-PSA): This is the acrylate-based pressure sensitive adhesive as described in Table 6a under examples of Patent Publication No. WO 2014/035981 A1 (Vinod et al.).

### Examples 1-4 and Comparative Examples C1-C4: Preparation of Adhesive Films

### Example 1 and Comparative Example C1: PU-PSA (Polyurea PSA) with and without Enzymes

For Example 1a a ten percent trypsin by weight solution was prepared in sterile water and added to PU-PSA formulation to obtain 0.5% of trypsin in the adhesive mix. For Example 1b Savinase was added to obtain 1% of the enzyme in the adhesive mix. The mixtures were mixed thoroughly for 24 h in a rotator and coated on PET Film at 152 micrometer (6 mil) thickness using a coater. The films were dried at 65° C. for 5 min and cured under high intensity UV exposure as described in example 11 of US Patent Publication No. 2011/0123800 (Sherman et al.). The cured films were lined with a release liner and stored in ZIPLOC bags at room temperature. Comparative Example C1 films were coated and cured similarly with adhesive formulation without enzymes.

For Examples 1c and 1d, enzymes were first solubilized in a carrier of PEG (Example 1c) or PEG-A (Example 1d) and mixed thoroughly for about 6 hrs and then the

PEG or PEG-A with enzymes was added to PU-PSA formulation to obtain 0.1% or 0.25% of trypsin or 0.1%, 0.5% or 1% Savinase in the adhesive mix. The mixtures were mixed thoroughly for 24 h in a rotator and coated and cured on PET Film at 152 micrometer (6 mil) thickness as described above. The cured films were lined with a release liner and stored in ZIPLOC bags at room temperature. As stated above, Comparative Example C1 films were coated and cured similarly with adhesive formulation without enzymes.

### Example 2 and Comparative Example C2: SIS-PSA (Styrene-isoprene-styrene PSA) with and without Enzymes

For Example 2a, a ten percent trypsin by weight solution was prepared in sterile water and added to SIS-PSA formulation to obtain 0.5% of trypsin in the adhesive mix. For Example 2b, Savinase was added to obtain 1% of the enzyme in the adhesive mix.

The mixtures were mixed thoroughly for 24 h in a rotator and coated on PET Film at 152 micrometer (6 mil) thickness using a coater. The films were cured by drying at 65° C. for 5 min. The cured films were lined with a release liner and stored in ZIPLOC bags at room temperature. Comparative Example C2 films were coated and cured similarly with adhesive formulation without enzymes.

### Example 3 and Comparative Example C3: SP-PSA (silicone polyoxamide PSA) with and without Enzymes

For Example 3a, a ten percent trypsin by weight solution was prepared in sterile water and added to SP-PSA formulation to obtain 0.5% of trypsin in the adhesive mix. For Example 3b, Savinase was added to obtain 1% of the enzyme in the adhesive mix. The mixtures were mixed thoroughly for 24h in a rotator and coated on PET Film at 152 micrometer (6 mil) thickness using a coater. The films were cured by drying at 65° C. for 5 min. The cured films were lined with a release liner and stored in ZIPLOC bags at room temperature. Comparative Example C3 films were coated and cured similarly with adhesive formulation without enzymes.

### Example 4 and Comparative Example C4: A-PSA (Acrylate-Based PSA) with and without Enzymes

For Example 4a, a ten percent trypsin by weight solution was prepared in sterile water and added to acrylate-PSA formulation to obtain 0.5% of trypsin in the adhesive mix. For Example 4b, Savinase was added to obtain 1% of the enzyme in the adhesive mix. The mixtures were mixed thoroughly for 24 h in a rotator and coated on PET Film at 152 micrometer (6 mil) thickness using a coater. The films were cured by drying at 70° C. for 5 min. The cured films were lined with a release liner and stored in ZIPLOC bags at room temperature. Comparative Example C4 films were coated and cured similarly with adhesive formulation without enzymes.

### Test Methods

### Test A: Enzyme Activity of Adhesive Films Containing Enzymes

The enzyme activity of proteases contained in the adhesive film was determined using the Azocasein assay (Tomarelli, R. M., et al The use of azoalbumin as a substrate in the colorimetric determination or peptic and tryptic activity, J Lab Clin Med. 34:428-33, 1949). Azocasein is a nonspecific protease substrate. Hydrolysis of the protein releases the azo dye into the media where it is detected by absorbance at 440 nm. In an initial experiment, 5×5 cm film was cut and placed in a 5 ml tube with the adhesive coated film facing the inside of the tube. 2.5 ml of 0.5% sodium bicarbonate buffer (pH 8.3) and 2.5 ml of 2.5% Azocasein solution in sodium bicarbonate buffer were added to the tube and incubated at 37° C. for 1 hour. Comparative Example tubes were set up similarly, but contained the adhesive film without the enzyme. After 1 hour at 37° C., 1 ml of the assay solution was removed and added to a tube containing 4 ml of 5% trichloro acetic acid and mixed thoroughly. The excess protein was precipitated with trichloro acetic acid and the solution was filtered through 0.45 micrometer GHP Acrodisc 25 mm syringe filters (Pall Life Sciences, Port Washington, N.Y.) using a syringe. 1 ml of the filtrate was added to a tube containing 3 ml of 0.5M sodium hydroxide and mixed thoroughly to neutralize the acid. The resulting solution was read in a spectrophotometer (SPECTRAMAX M5, Molecular Devices, Sunnyvale, Calif.) at 440 nm to measure the absorbance. The data for Examples 1-4 and Comparative Examples C1-C4 are presented in Table 1 below. The absorbance readings were much higher with the films containing the enzymes, indicating that the enzyme contained in the films are active.

TABLE 1
Enzyme activity of adhesive films containing enzymes

| Example | OD at 440 nm |
|---|---|
| C1 | 0.055 |
| 1a | 0.355 |
| 1b | 0.479 |
| C2 | 0.065 |
| 2a | 0.245 |
| 2b | 0.439 |
| C3 | 0.085 |
| 3a | 0.195 |
| 3b | 0.295 |
| C4 | 0.120 |
| 4a | 0.231 |
| 4b | 0.367 |

### Test B: Enzyme Activity of Adhesive Films Containing Enzymes Over Time at 37° C.

Samples of the adhesive films with 1% Savinase and comparative adhesive films were tested as described as described above with a 3×3 cm film and the enzyme activity was determined at periodic intervals. The samples were incubated at 37° C. and the assay detection was modified as described below. In the modified procedure, 0.1 ml of the assay mixture was removed to a 1.5 ml microfuge tube, precipitated with 0.4 ml of 5% TCA and the solution was spun at 14,000 rpm (20,817 rcf) in a microcentrifuge (Model 5417R, Eppendorf, Hauppauge, N.Y.). The supernatant was removed and 70 microliters of the solution was added to a clear flat-bottom immuno sterile 96-well microtiter plate (THERMO SCIENTIFIC MAXISORP, Thermo Fisher Scientific, Rochester, N.Y.) and neutralized with 210 microliters of 0.5 M NaOH. The solution was mixed and read in plate reader (SPECTRAMAX PLUS, Molecular devices) at 440 nm to measure the absorbance. The data are presented in Table 2 below. As seen in Table 2, the comparative films did not show any activity while the film with enzyme continued to show activity up to 3 hrs.

TABLE 2
Azocasein assay with adhesive films containing enzymes

OD at 440 nm

| Example | 30 min | 1 hr | 2 hr | 3 hr |
|---|---|---|---|---|
| C1 | 0.065 | 0.07 | 0.08 | 0.085 |
| 1b | 0.193 | 0.323 | 0.428 | 0.508 |
| C2 | 0.048 | 0.055 | 0.064 | 0.075 |
| 2b | 0.258 | 0.441 | 0.585 | 0.668 |
| C3 | 0.103 | 0.103 | 0.12 | 0.125 |
| 3b | 0.17 | 0.288 | 0.393 | 0.445 |
| C4 | 0.120 | 0.120 | 0.153 | 0.148 |
| 4b | 0.228 | 0.355 | 0.415 | 0.505 |

### Test C: Enzyme Activity of Adhesive Films Containing Enzymes Over Longer Time Periods at 37° C.

Enzyme activity of adhesive films containing enzymes were tested at 37° C. using a 3×3 cm film and the enzyme activity was determined at periodic intervals as described in Test B above. The data are presented in Table 3 below. As seen in Table 3, the enzyme activity continued to go up to 4 days.

TABLE 3
Azocasein assay with adhesive films
containing enzymes at 37° C.

| | OD 440 nm | | | | | |
|---|---|---|---|---|---|---|
| Example | 30 min | 1 hr | 24 hr | 48 hr | 72 hr | 96 hr |
| Control | 0.095 | 0.101 | 0.105 | 0.101 | 0.103 | 0.115 |
| (no film) | | | | | | |
| C1 | 0.104 | 0.097 | 0.111 | 0.115 | 0.135 | 0.155 |
| 1a | 0.169 | 0.265 | 0.464 | 0.703 | 0.816 | 1.034 |
| 1b | 0.221 | 0.309 | 0.52 | 0.863 | 0.986 | 1.260 |
| C2 | 0.1 | 0.102 | 0.141 | 0.167 | 0.195 | 0.21 |
| 2a | 0.214 | 0.284 | 0.483 | 0.764 | 0.869 | 1.110 |
| 2b | 0.329 | 0.419 | 0.564 | 0.911 | 1.052 | 1.358 |
| C3 | 0.1 | 0.097 | 0.142 | 0.157 | 0.161 | 0.195 |
| 3a | 0.132 | 0.192 | 0.325 | 0.415 | 0.555 | 0.582 |
| 3b | 0.23 | 0.303 | 0.528 | 0.593 | 0.744 | 0.798 |
| C4 | 0.120 | 0.120 | 0.153 | 0.148 | 0.155 | 0.158 |
| 4a | 0.120 | 0.153 | 0.223 | 0.326 | 0.380 | 0.449 |
| 4b | 0.228 | 0.367 | 0.516 | 0.755 | 0.892 | 0.985 |

### Test D: Enzyme Activity of Adhesive Films Containing Enzymes Over Longer Time Periods at Room Temperature

The adhesive films were tested similarly by incubating at room temperature. At periodical intervals, enzyme activity was measured as described in Test B above. The data are presented in Table 4. As seen in Table 4, the enzyme activity continued to go up after 4 days at room temperature.

TABLE 4
Azocasein assay with adhesive films
containing enzymes at room temperature

| | OD 440 nm | | | | | |
|---|---|---|---|---|---|---|
| Example | 30 min | 1 Hr | 24 hr | 48 hr | 72 hr | 96 hr |
| Control | 0.093 | 0.096 | 0.099 | 0.112 | 0.094 | 0.098 |
| (no film) | | | | | | |
| C1 | 0.096 | 0.098 | 0.110 | 0.135 | 0.134 | 0.149 |
| 1a | 0.164 | 0.206 | 0.401 | 0.464 | 0.489 | 0.492 |
| 1b | 0.193 | 0.223 | 0.452 | 0.560 | 0.586 | 0.588 |
| C2 | 0.105 | 0.098 | 0.143 | 0.152 | 0.162 | 0.159 |
| 2a | 0.185 | 0.231 | 0.404 | 0.526 | 0.553 | 0.554 |
| 2b | 0.258 | 0.341 | 0.521 | 0.607 | 0.631 | 0.634 |
| C3 | 0.097 | 0.099 | 0.105 | 0.120 | 0.118 | 0.156 |
| 3a | 0.112 | 0.162 | 0.254 | 0.375 | 0.455 | 0.515 |
| 3b | 0.136 | 0.185 | 0.405 | 0.545 | 0.585 | 0.605 |
| C4 | 0.102 | 0.120 | 0.133 | 0.140 | 0.152 | 0.155 |
| 4a | 0.120 | 0.143 | 0.203 | 0.286 | 0.310 | 0.409 |
| 4b | 0.198 | 0.267 | 0.412 | 0.535 | 0.598 | 0.576 |

### Test E: Enzyme Activity of Water Washed Adhesive Films Containing Enzymes Over Longer Time Periods at Room Temperature

In the first portion of the test, enzyme activity of adhesive films containing enzymes were tested at room temperature using a 3×3 cm film and the enzyme activity was determined at periodic intervals as described in Test B above. These Data are shown in Table 5 below. At the end of 96 hr of incubation, the films were removed, washed with clean water and dried at room temperature for 24 hrs. The dried films were retested for enzymatic activity as described in Test D above. These data are shown in Table 6 below. Tables 5 and 6 indicate that the enzymes were stabilized in the adhesive matrix and were not leaching out.

TABLE 5
Azocasein assay with adhesive films
containing enzymes at room temperature

| | OD 440 nm | | | | | |
|---|---|---|---|---|---|---|
| Example | 1 hr | 2 hr | 24 hr | 48 hr | 72 hr | 96 hr |
| Control | 0.116 | 0.122 | 0.130 | 0.134 | 0.138 | 0.140 |
| (no film) | | | | | | |
| C1 | 0.124 | 0.134 | 0.133 | 0.173 | 0.174 | 0.179 |
| 1a | 0.211 | 0.412 | 0.499 | 0.672 | 0.789 | 0.792 |
| 1b | 0.357 | 0.449 | 0.725 | 0.936 | 1.086 | 0.988 |
| C2 | 0.116 | 0.117 | 0.128 | 0.121 | 0.162 | 0.159 |
| 2a | 0.249 | 0.351 | 0.469 | 0.649 | 0.753 | 0.794 |
| 2b | 0.327 | 0.498 | 0.768 | 0.895 | 0.983 | 0.934 |

TABLE 6
Retesting of enzyme activity of water washed adhesive films
containing enzymes at room temperature after l^{st} set of testing

| | OD 440 nm | | | | | |
|---|---|---|---|---|---|---|
| Example | 1 hr | 2 hr | 24 hr | 48 hr | 72 hr | 96 hr |
| Control | 0.116 | 0.122 | 0.130 | 0.134 | 0.138 | 0.140 |
| (no film) | | | | | | |
| C1 | 0.139 | 0.140 | 0.145 | 0.176 | 0.180 | 0.185 |
| 1a | 0.195 | 0.328 | 0.445 | 0.596 | 0.654 | 0.678 |
| 1b | 0.175 | 0.275 | 0.467 | 0.711 | 0.912 | 0.985 |
| C2 | 0.125 | 0.135 | 0.141 | 0.148 | 0.158 | 0.165 |
| 2a | 0.282 | 0.351 | 0.537 | 0.686 | 0.859 | 0.878 |
| 2b | 0.212 | 0.378 | 0.631 | 0.899 | 1.132 | 1.126 |

### Test F: Enzyme Activity of Adhesive Films Prepared by Addition of Enzyme in a Carrier Vehicle

The films prepared using enzymes in a carrier vehicle added to adhesive mix as described in Examples 1c and 1d were tested for enzymatic activity at room temperature using a 3×3 cm film and the enzyme activity was determined at periodic intervals and after water washing as described in Test E above. The data are presented in Tables 7 and 8 below. As seen in Table 7, the enzyme activity continued to go up to 4 days at room temperature. At the end of 96 hr of incubation, some of the films were removed, washed with clean water and dried at room temperature for 24 hrs. The dried films were retested for enzymatic activity as described in Test E above. As seen in Table 8, the initial enzyme activity continued to go up to 4 days. When the films were removed, washed and retested, they retained the enzyme activity and continue to again show the activity indicating that the enzymes were stabilized in the adhesive matrix and were not leaching out.

TABLE 7
Azocasein assay with adhesive films
containing enzymes at room temperature

| | OD 440 nm | | | | | |
|---|---|---|---|---|---|---|
| Example | 1 hr | 2hr | 24 hr | 48 hr | 72 hr | 96 hr |
| C1 | 0.114 | 0.122 | 0.114 | 0.118 | 0.134 | 0.133 |
| 1d with 0.1% trypsin | 0.192 | 0.195 | 0.439 | 0.636 | 0.770 | 0.745 |
| 1d with 0.25% trypsin | 0.230 | 0.249 | 0.499 | 0.672 | 0.821 | 0.802 |
| 1d with 0.1% Savinase | 0.178 | 0.188 | 0.514 | 0.720 | 0.978 | 1.018 |
| 1d with 0.5% Savinase | 0.297 | 0.299 | 0.657 | 0.814 | 1.041 | 1.006 |
| 1d with 1% Savinase | 0.388 | 0.391 | 0.839 | 0.933 | 1.113 | 1.099 |
| C1 | 0.118 | 0.125 | 0.130 | 0.138 | 0.143 | 0.153 |
| 1c with 0.25% trypsin | 0.221 | 0.262 | 0.454 | 0.612 | 0.786 | 0.810 |
| 1c with 0.5% Savinase | 0.245 | 0.285 | 0.615 | 0.769 | 0.989 | 0.956 |
| 1c with 1% Savinase | 0.335 | 0.389 | 0.792 | 0.895 | 1.001 | 0.998 |

TABLE 8
Retesting of enzyme activity of water washed adhesive films containing
enzymes at room temperature after 1^{st} set of testing

| | OD 440 nm | | | | |
|---|---|---|---|---|---|
| Example | 1 hr | 24 hr | 48 hr | 72 hr | 96 hr |
| C1 | 0.133 | 0.153 | 0.155 | 0.165 | 0.170 |
| 1 d with 0.1% trypsin | 0.137 | 0.253 | 0.339 | 0.445 | 0.515 |
| 1 d with 0.25% trypsin | 0.133 | 0.323 | 0.446 | 0.523 | 0.595 |
| 1 d with 0.1% Savinase | 0.133 | 0.289 | 0.375 | 0.483 | 0.555 |
| 1 d with 0.5% Savinase | 0.138 | 0.353 | 0.458 | 0.625 | 0.865 |
| 1 d with 1% Savinase | 0.166 | 0.391 | 0.475 | 0.655 | 0.696 |

### Test G: Enzyme Activity of Adhesive Films Containing Enzymes After Long Term Aging

The adhesive films containing enzymes were stored at room temperature in a ZIPLOC bag in a lab cabinet. At periodic intervals enzyme activity was tested at room temperature using a 3×3 cm film and as described in Test B above. As seen in Tables 9a-9e, the films are very stable up to 15 months and showed good enzyme activity even after 15 months of coating the adhesive.

### Tables 9a-9e. Azocasein Assay with Adhesive Films Containing Enzymes Stored at Room Temperature for Various Periods

TABLE 9a
Films stored for 3 months

| | OD 440 nm | | | | |
|---|---|---|---|---|---|
| Example | 1 hr | 2 hr | 24 hr | 48 hr | 72 hr |
| Control (no film) | 0.106 | 0.124 | 0.134 | 0.144 | 0.540 |
| C1 | 0.133 | 0.138 | 0.144 | 0.165 | 0.178 |
| 1a | 0.245 | 0.401 | 0.523 | 0.712 | 0.806 |
| 1b | 0.369 | 0.474 | 0.698 | 0.878 | 0.984 |
| C2 | 0.121 | 0.125 | 0.137 | 0.145 | 0.159 |
| 2a | 0.251 | 0.379 | 0.496 | 0.672 | 0.801 |
| 2b | 0.345 | 0.523 | 0.678 | 0.845 | 0.912 |

TABLE 9b
Films stored for 6 months

| | OD 440 nm | | | | |
|---|---|---|---|---|---|
| Example | 1 hr | 2 hr | 24 hr | 48 hr | 72 hr |
| Control (no film) | 0.122 | 0.132 | 0.144 | 0.152 | 0.148 |
| C1 | 0.136 | 0.145 | 0.149 | 0.182 | 0.189 |
| 1a | 0.217 | 0.347 | 0.465 | 0.578 | 0.644 |
| 1b | 0.275 | 0.403 | 0.647 | 0.794 | 0.903 |
| C2 | 0.119 | 0.132 | 0.139 | 0.151 | 0.162 |
| 2a | 0.296 | 0.392 | 0.512 | 0.703 | 0.886 |
| 2b | 0.235 | 0.368 | 0.612 | 0.848 | 0.986 |

TABLE 9c
Films stored for 9 months

| | OD 440 nm | | | | |
|---|---|---|---|---|---|
| Example | 1 hr | 2 hr | 24 hr | 48 hr | 72 hr |
| Control (no film) | 0.109 | 0.121 | 0.128 | 0.147 | 0.156 |
| C1 | 0.127 | 0.132 | 0.144 | 0.158 | 0.165 |
| 1a | 0.234 | 0.388 | 0.501 | 0.602 | 0.648 |
| 1b | 0.267 | 0.389 | 0.614 | 0.782 | 0.892 |
| C2 | 0.122 | 0.138 | 0.144 | 0.165 | 0.171 |
| 2a | 0.278 | 0.375 | 0.497 | 0.676 | 0.868 |
| 2b | 0.226 | 0.347 | 0.601 | 0.812 | 0.923 |

TABLE 9d
Films stored for 12 months

| | OD 440 nm | | | | |
|---|---|---|---|---|---|
| Example | 1 hr | 2 hr | 24 hr | 48 hr | 72 hr |
| Control (no film) | 0.052 | 0.065 | 0.065 | 0.065 | 0.067 |
| C1 | 0.069 | 0.070 | 0.070 | 0.062 | 0.068 |
| 1a | 0.21 | 0.299 | 0.524 | 0.543 | 0.623 |
| 1b | 0.211 | 0.328 | 0.592 | 0.643 | 0.732 |
| C2 | 0.059 | 0.064 | 0.061 | 0.064 | 0.071 |
| 2a | 0.122 | 0.187 | 0.406 | 0.552 | 0.533 |
| 2b | 0.294 | 0.416 | 0.688 | 0.725 | 0.839 |

TABLE 9e
Films stored for 15 months

| | OD 440 nm | | | | |
|---|---|---|---|---|---|
| Example | 1 hr | 2 hr | 24 hr | 48 hr | 72 hr |
| Control (no film) | 0.062 | 0.069 | 0.075 | 0.081 | 0.085 |
| C1 | 0.075 | 0.081 | 0.085 | 0.092 | 0.095 |
| 1a | 0.223 | 0.285 | 0.502 | 0.578 | 0.612 |
| 1b | 0.234 | 0.365 | 0.602 | 0.663 | 0.754 |
| C2 | 0.063 | 0.075 | 0.083 | 0.085 | 0.088 |
| 2a | 0.145 | 0.198 | 0.423 | 0.578 | 0.545 |
| 2b | 0.303 | 0.456 | 0.673 | 0.712 | 0.845 |

For 15 month aged samples, at the end of 72 hr of incubation, the films were removed, washed with clean water, dried at room temperature for 24 hrs. The dried films were retested for enzymatic activity as described in Test D above. The data are presented in Table 10 below. The films aged for 15 months still retained the enzyme activity in the film after the 1^{st} set of enzyme assays indicating that enzymes were stabilized in the adhesive matrix and were not leaching out.

TABLE 10
Retesting of enzyme activity of adhesive films
containing enzymes at room temperature after 1^{st}
set of testing of samples aged for 15 months

| | OD 440 nm | | | | |
|---|---|---|---|---|---|
| Example | 1 hr | 2 hr | 24 hr | 48 hr | 72 hr |
| Control (no film) | 0.068 | 0.062 | 0.067 | 0.064 | 0.090 |
| C1 | 0.063 | 0.055 | 0.060 | 0.070 | 0.088 |
| 1a | 0.155 | 0.186 | 0.324 | 0.415 | 0.475 |
| 1b | 0.178 | 0.255 | 0.395 | 0.503 | 0.594 |
| C2 | 0.066 | 0.064 | 0.069 | 0.071 | 0.081 |
| 2a | 0.102 | 0.162 | 0.304 | 0.455 | 0.468 |
| 2b | 0.192 | 0.306 | 0.459 | 0.567 | 0.617 |

### Test H: Light Transmission Measurements of Adhesive Films With or Without Enzymes

A 2×4 cm film sample was cut from the adhesive films with or without enzymes and the film was adhered to a clean glass slide (VISTAVISION plain Microscope Slides, VWR, Radnor, Pa.). The glass slide with the film was placed on the cuvette adapter of Tecan Infinite M200 PRO multimode reader (Tecan US, Inc. Durham, N.C.). The optical density spectrum scan was performed from 400 nm to 700 nm using the Tecan Infinite M200 PRO multimode reader (Tecan US, Inc.). The average light transmittance across the film surface was calculated. The data are presented in Table 11. As seen in Table 11, the various films had about 86 to 92% light transmission, and the addition of enzymes to adhesives did not alter % light transmittance.

TABLE 11
Light transmission of adhesive films containing enzymes

| | % Light transmittance | | | | | | | |
|---|---|---|---|---|---|---|---|---|
| | 400 | 450 | 500 | 550 | 600 | 650 | 700 | 750 |
| Example | nm | nm | nm | nm | nm | nm | nm | nm |
| C1 | 88.7 | 89.5 | 89.9 | 89.9 | 89.7 | 89.7 | 89.7 | 89.5 |
| 1b | 89.9 | 90.8 | 91.0 | 91.0 | 90.8 | 90.6 | 90.8 | 90.4 |
| 1a | 86.3 | 87.5 | 88.1 | 88.3 | 88.5 | 88.5 | 89.1 | 89.1 |
| C2 | 91.1 | 91.3 | 91.5 | 91.6 | 91.7 | 91.7 | 91.7 | 91.6 |
| 2b | 86.3 | 86.6 | 87.2 | 87.5 | 89.5 | 89.5 | 89.5 | 89.5 |
| 2a | 86.5 | 86.7 | 88.1 | 88.9 | 89.3 | 89.7 | 89.9 | 90.2 |
| C3 | 88.5 | 89.9 | 89.9 | 90.2 | 90.2 | 90.2 | 90.2 | 90.2 |
| 3b | 86.1 | 86.1 | 86.3 | 86.5 | 86.9 | 87.3 | 87.7 | 88.1 |

### Test I: 180° Peel Adhesion of Adhesive Films With or Without Enzymes

This test is a modification of the standard test method ASTM D 3330-90 using a glass substrate instead of stainless steel. A test sample was prepared by placing a 0.5 (12.2 cm) inch wide by 7 inch (178 cm) long adhesive coated tape on a 100 cm by 250 cm glass. The plates were cleaned by wiping with isopropanol before testing. The tape was rolled down onto the panel with two passes of a 2 kg roller. The test was conducted on a slip/peel tester (Instrumentors Inc., Strongsville, Ohio). The tape was removed from the plate at a peel angle of 180° and a platen speed of 90 inches per minute (2.288 m/min) for a total of 2 seconds after aging on the glass substrate. The aging was for 10 min at 23° C. The force required to remove the tape was measured in grams per 0.5 inch and converted to Newtons/decimeter (N/dm). Results are the average of three tests on each adhesive and shown in Table 12.

TABLE 12
180° Peel Adhesion

| Example | N/dm |
|---|---|
| C1 | 1.40 |
| 1b | 1.47 |
| C2 | 1.41 |
| 2b | 1.54 |

### Test J: Kinetic Assay of Enzyme Activity of Adhesive Films Containing Enzymes

The films prepared using enzymes in a carrier vehicle (PEG-A) added to adhesive mix as described in Example 1d were tested for kinetic enzymatic activity at room temperature as described below. The protease substrate N-succinyl-L-phenylalanine-p-nitroanilide (NSLPN, Sigma Aldrich) and trypsin substrate N-α-benzoyl-DL-arginine 4-nitroanilide hydrochloride (BAPNA, Sigma Aldrich) were used as described by Pastor et al. (Pastor, I. et al. Effect of crowding by dextrans on the hydrolysis of N-Succinyl-L-phenylalanine-p-nitroanilide catalyzed by α-chymotrypsin, J Phys. Chem. B, 115:1115-1121, 2011). The assay method used was modified as described below. A 50 mM solution of the substrate was made in DMSO (dimethyl sulfoxide, Sigma Aldrich) and used at 250 micromolar in the assay mixture by diluting the substrate in 0.1M TRIS-HCl, pH 8.0 buffer containing 10 mM CaCl₂. One ml of the assay mixture was added to a 24-well tissue culture plate (COSTAR 24 Well Clear Flat Bottom cell culture plates, Corning Inc. Life Sciences, Tewksbury, Mass.) and a 1×1 cm film was immersed in the solution. The plates were read in Tecan Infinite M200 PRO multimode reader (Tecan US, Inc.) under kinetic mode at 405 nm every 20 min up to 8 hrs. The data obtained are shown in Table 13 and 14 and the adhesive films with enzymes showed the enzyme activity and the activity increased over time. The comparative adhesive films without enzymes did not show any activity.

TABLE 13
Enzyme assay of Savinase containing adhesive film with
substrate N-succinyl-L-phenylalanine-p-nitroanilide

| | Optical density at 405 nm | | |
|---|---|---|---|
| Time | | PU-PSA with | PU-PSA with |
| (min) | Example C1 | 0.5% Savinase | 1% Savinase |
| 0 | 0.127 | 0.165 | 0.282 |
| 20 | 0.132 | 0.167 | 0.291 |
| 40 | 0.137 | 0.169 | 0.301 |
| 60 | 0.132 | 0.174 | 0.313 |
| 80 | 0.134 | 0.183 | 0.334 |
| 100 | 0.133 | 0.186 | 0.347 |
| 120 | 0.133 | 0.191 | 0.374 |
| 140 | 0.130 | 0.204 | 0.386 |
| 160 | 0.133 | 0.216 | 0.396 |
| 180 | 0.132 | 0.233 | 0.409 |
| 200 | 0.132 | 0.249 | 0.428 |
| 220 | 0.132 | 0.266 | 0.440 |
| 240 | 0.133 | 0.286 | 0.462 |
| 260 | 0.135 | 0.295 | 0.485 |
| 280 | 0.133 | 0.302 | 0.523 |
| 300 | 0.135 | 0.315 | 0.547 |
| 320 | 0.135 | 0.326 | 0.578 |
| 340 | 0.136 | 0.328 | 0.589 |
| 360 | 0.135 | 0.329 | 0.591 |
| 380 | 0.136 | 0.329 | 0.599 |
| 400 | 0.137 | 0.331 | 0.605 |
| 420 | 0.138 | 0.333 | 0.609 |
| 440 | 0.138 | 0.334 | 0.610 |
| 460 | 0.138 | 0.336 | 0.613 |
| 480 | 0.138 | 0.339 | 0.616 |
| 500 | 0.134 | 0.340 | 0.618 |

TABLE 14
Enzyme assay of trypsin containing adhesive film with substrate
N-α-benzoyl-DL-arginine 4-nitroanilide hydrochloride

Optical density at 405 nm

| | | PU-PSA | PU-PSA | PU-PSA |
|---|---|---|---|---|
| Time | Example | with 0.1% | with 0.25% | with 1% |
| (min) | C1 | trypsin | trypsin | trypsin |
| 0 | 0.142 | 0.144 | 0.139 | 0.207 |
| 20 | 0.142 | 0.172 | 0.187 | 0.301 |
| 40 | 0.143 | 0.212 | 0.239 | 0.399 |
| 60 | 0.143 | 0.238 | 0.285 | 0.467 |
| 80 | 0.145 | 0.256 | 0.322 | 0.528 |
| 100 | 0.145 | 0.271 | 0.352 | 0.583 |
| 120 | 0.146 | 0.289 | 0.376 | 0.634 |
| 140 | 0.146 | 0.306 | 0.396 | 0.678 |
| 160 | 0.145 | 0.323 | 0.413 | 0.719 |
| 180 | 0.146 | 0.339 | 0.427 | 0.755 |
| 200 | 0.145 | 0.354 | 0.439 | 0.785 |
| 220 | 0.145 | 0.369 | 0.450 | 0.814 |
| 240 | 0.145 | 0.382 | 0.459 | 0.839 |
| 260 | 0.145 | 0.396 | 0.468 | 0.859 |
| 280 | 0.146 | 0.408 | 0.476 | 0.877 |
| 300 | 0.145 | 0.420 | 0.483 | 0.893 |
| 320 | 0.145 | 0.431 | 0.489 | 0.907 |
| 340 | 0.146 | 0.442 | 0.493 | 0.919 |
| 360 | 0.145 | 0.452 | 0.494 | 0.930 |
| 380 | 0.146 | 0.461 | 0.496 | 0.939 |
| 400 | 0.147 | 0.470 | 0.502 | 0.948 |
| 420 | 0.148 | 0.478 | 0.508 | 0.956 |
| 440 | 0.148 | 0.486 | 0.511 | 0.964 |
| 460 | 0.148 | 0.494 | 0.517 | 0.970 |
| 480 | 0.148 | 0.500 | 0.521 | 0.977 |
| 500 | 0.145 | 0.507 | 0.519 | 0.983 |

### Test K: Enzyme Activity of Adhesive Films

The films prepared using enzymes in a carrier vehicle (PEG-A) added to adhesive mix as described in Example 1d were tested for their enzyme activity on a glass slide (VISTAVISION plain Microscope Slides, VWR). The slides were cleaned by wiping with isopropanol and allowed to dry. Assay mixture containing 250 micromolar of NSLPN or BAPNA was prepared as described in Test J above. 50 microliters of the assay mixture was spotted on the center of the glass slide and allowed to dry at room temperature. A 1×3 cm adhesive film with and without enzymes was adhered to the glass slide with dried substrate solution and kept at room temperature. At periodical intervals, the optical density at 405 nm was read by placing glass slide with the film on the cuvette adapter of Tecan Infinite M200 PRO multimode reader (Tecan US, Inc.). The data obtained are shown in Table 15 and the adhesive films with enzymes were able to degrade the spotted enzyme assay mixture on the glass substrate as indicated by an increase in optical density.

TABLE 15
Enzyme activity of adhesive films containing
enzymes on a glass substrate

| | Optical density at 405 nm | | | |
|---|---|---|---|---|
| | NSLPN-coated substrate | | BAPNA-coated substrate | |
| Time | Example | PU-PSA with | Example | PU-PSA with |
| (days) | C1 | 1% Savinase | C1 | 1% trypsin |
| 0 | 0.127 | 0.135 | 0.142 | 0.144 |
| 1 | 0.132 | 0.168 | 0.142 | 0.172 |
| 2 | 0.137 | 0.198 | 0.143 | 0.212 |
| 3 | 0.132 | 0.233 | 0.143 | 0.278 |
| 4 | 0.134 | 0.265 | 0.145 | 0.335 |
| 5 | 0.133 | 0.305 | 0.145 | 0.394 |
| 6 | 0.133 | 0.344 | 0.146 | 0.445 |
| 7 | 0.13 | 0.378 | 0.146 | 0.498 |
| 8 | 0.133 | 0.405 | 0.145 | 0.522 |
| 9 | 0.132 | 0.425 | 0.146 | 0.535 |
| 10 | 0.132 | 0.435 | 0.145 | 0.538 |

What is claimed is:

1. A pressure sensitive adhesive article comprising:
a substrate; and
a layer of pressure sensitive adhesive in contact with the substrate, wherein the pressure sensitive adhesive layer comprises:
a pressure sensitive adhesive matrix; and
at least one active enzyme dispersed within the pressure sensitive adhesive matrix.

2. The pressure sensitive adhesive article of claim 1, wherein the pressure sensitive adhesive matrix comprises at least one of a polyurea pressure sensitive adhesive polymer, a block copolymer pressure sensitive adhesive polymer, a silicone pressure sensitive adhesive polymer, or a (meth)acrylate-based pressure sensitive adhesive polymer.

3. The pressure sensitive adhesive article of claim 1, where the pressure sensitive adhesive article is optically clear.

4. The pressure sensitive adhesive article of claim 1, wherein the active enzyme comprises at least one of amidases, carbohydrases, cellulases, deaminases, esterases, lipases, phospholipases, nucleases, oxidoreductases, peroxidases, proteases, carboxypeptidases, thiol reductase, acylases, aminocyclases, elastase, lactonases, or lysozyme.

5. The pressure sensitive adhesive article of claim 1, wherein the substrate comprises a rigid substrate, a tape backing, an optical film, or a release liner.

6. The pressure sensitive adhesive article of claim 5, wherein the substrate comprises an optical film comprising polyester, polycarbonate, poly(meth)acrylate, polyurethane, polyolefin, or combinations or blends thereof.

7. The pressure sensitive adhesive article of claim 1, wherein the active enzyme remains active for at least 6 months at ambient temperature.

8. The pressure sensitive adhesive article of claim 1, wherein the 180° Peel Adhesion to a glass substrate is unchanged from the 180° Peel Adhesion to a glass substrate of the same pressure sensitive adhesive matrix without the presence of the active enzyme.

9. The pressure sensitive adhesive article of claim 1, further comprising a carrier agent dispersed within the pressure sensitive adhesive matrix.

10. An adhesive laminate comprising:
a first substrate;
a second substrate; and
a layer of pressure sensitive adhesive in contact with the first substrate and the second
substrate, wherein the pressure sensitive adhesive layer comprises:
a pressure sensitive adhesive matrix; and
at least one active enzyme dispersed within the pressure sensitive adhesive matrix.

11. The adhesive laminate of claim 10, wherein the pressure sensitive adhesive matrix comprises at least one of a polyurea pressure sensitive adhesive polymer, a block copolymer pressure sensitive adhesive polymer, a silicone pressure sensitive adhesive polymer, or a (meth)acrylate-based pressure sensitive adhesive polymer.

12. The adhesive laminate of claim 10, where the adhesive laminate is optically clear.

13. The adhesive laminate of claim 10, wherein the active enzyme comprises at least one of amidases, carbohydrases, cellulases, deaminases, esterases, lipases, phospholipases, nucleases, oxidoreductases, peroxidases, proteases, carboxypeptidases, thiol reductase, acylases, aminocyclases, elastase, lactonases, or lysozyme.

14. The adhesive laminate of claim 10, wherein the each of the first and second substrates independently comprises a rigid substrate, a tape backing, an optical film, or a release liner.

15. The adhesive laminate of claim 14, wherein the first substrate comprises an optical film comprising polyester, polycarbonate, poly(meth)acrylate, polyurethane, polyolefin, or combinations or blends thereof.

16. The adhesive laminate of claim 11, wherein the active enzyme remains active for at least one year at ambient temperature.

17. A method of making an adhesive article, comprising:
providing a first substrate with a first major surface and a second major surface;
providing a pressure sensitive adhesive or a pressure sensitive adhesive precursor mixture composition;
contacting the pressure sensitive adhesive or pressure sensitive adhesive precursor mixture composition to the first major surface of the first substrate; and
forming the pressure sensitive adhesive or pressure sensitive adhesive precursor mixture composition into a pressure sensitive adhesive layer, wherein the pressure sensitive adhesive layer or pressure sensitive adhesive precursor mixture composition
comprises:
a polymeric matrix or pre-polymeric reactive mixture; and
at least one active enzyme dispersed within the polymeric matrix or pre-polymeric reactive mixture.

18. The method of claim 17, wherein the at least one active enzyme dispersed within the polymeric matrix or pre-polymeric reactive mixture further comprises water.

19. The method of claim 17, wherein forming the pressure sensitive adhesive or pressure sensitive adhesive precursor mixture composition into a pressure sensitive adhesive layer, comprises curing, drying, cooling, allowing the pressure sensitive adhesive to dwell at room temperature, or a combination thereof, such that a layer is formed comprising a pressure sensitive adhesive matrix with at least one active enzyme dispersed within the pressure sensitive adhesive matrix.

20. The method of claim 17, wherein providing a pressure sensitive adhesive or a pressure sensitive adhesive precursor mixture composition comprises mixing a pressure sensitive adhesive polymer or pressure sensitive adhesive pre-polymer composition with an active enzyme.

21. The method of claim 17, wherein providing a pressure sensitive adhesive or a pressure sensitive adhesive precursor mixture composition comprises forming a mixture of an active enzyme and a carrier agent and mixing the mixture of an active enzyme and a carrier agent with a pressure sensitive adhesive polymer or pressure sensitive adhesive pre-polymer composition.

22. The method of claim 17, wherein the first major surface of the first substrate comprises organic contamination or wherein upon contacting the first major surface of the first substrate with the pressure sensitive adhesive or pressure sensitive adhesive precursor mixture composition bubbles form at the interface, such that the organic contamination or bubbles are visible to the naked eye after forming the pressure sensitive adhesive layer, and wherein the organic contamination or bubbles visible to the naked eye are not visible to the naked eye after the construction comprising the first substrate and pressure sensitive adhesive layer has dwelled at room temperature for 1 week.

23. The method of claim 17, further comprising providing a second substrate and contacting the pressure sensitive adhesive layer to the second substrate to form a laminate article.
